(19) United States
(12) Patent Application Publication
(10) Pub. No.: US 2024/0219526 A1
(43) Pub. Date: Jul. 4, 2024

(54) ILLUMINATION DEVICE AND RANGING DEVICE

(71) Applicant: SONY SEMICONDUCTOR SOLUTIONS CORPORATION, KANAGAWA (JP)

(72) Inventors: KYOHEI YAMADA, KANAGAWA (JP); MOTOI KIMURA, KANAGAWA (JP); KOUJI MORI, KUMAMOTO (JP); TATSUYA OIWA, KANAGAWA (JP); TAKASHI KOBAYASHI, KANAGAWA (JP)

(21) Appl. No.: 18/551,995

(22) PCT Filed: Feb. 15, 2022
(86) PCT No.: PCT/JP2022/005853

§ 371 Date: Sep. 22, 2023

(30) Foreign Application Priority Data
Apr. 12, 2021 (JP) 2021-066950

(51) Int. Cl. G01S 7/481; G01S 7/484; G01S 17/894

(52) U.S. Cl. CPC G01S 7/4814; G01S 7/484; G01S 17/894

(57) ABSTRACT

For example, an influence of a series resonant circuit formed when a switching unit is turned off is reduced. An illumination device includes a light emission element including a first light emission unit group including a plurality of first light emission units and a second light emission unit group including a plurality of second light emission units, a first electrode of the first light emission unit group and a second electrode of the second light emission unit group made common, a first switching unit connected between a power supply and a third electrode of the first light emission unit group, a second switching unit connected between the power supply and a fourth electrode of the second light emission unit group, and at least one capacitor connected to a connection point between the power supply and the first switching unit and second switching unit.

### TECHNICAL FIELD

The present technology relates to an illumination device and a ranging device.

### BACKGROUND ART

There have been proposed various ranging methods (for example, a time of flight (ToF) method) for measuring a distance to a measuring target by irradiating the measuring target with light emitted from a plurality of light emission units and receiving reflection light from the measuring target. For example, Patent Document 1 discloses a vertical cavity surface emitting laser (VCSEL) using GaAs, InP and the like as a substrate used for ranging.

### CITATION LIST

### Patent Document

Patent Document 1: Japanese Patent Application Laid-Open No. 2011-61083

### SUMMARY OF THE INVENTION

### Problems to be Solved by the Invention

In an illumination device used for ranging, a configuration in which a decoupling capacitor is connected to a site as close as possible to a light emission unit is considered. With such a configuration, charge accumulated in the decoupling capacitor can be supplied to the light emission unit in a short time, and modulation of a large current with high responsiveness can be implemented. However, in a case of the illumination device including a plurality of channels, the illumination device capable of individually driving each channel, there has been a problem that a series resonant circuit (LC series resonant circuit) is formed with an off-side light emission unit and the decoupling capacitor as elements having capacitance (C) and wiring by wire bonding as an element having inductance (L), and frequency characteristics deteriorate.

An object of the present technology is to provide an illumination device and a ranging device that suppress deterioration in frequency characteristics due to a series resonant circuit.

### Solutions to Problems

The present technology is an illumination device including:

a light emission element including a first light emission unit group including a plurality of first light emission units and a second light emission unit group including a plurality of second light emission units, a first electrode of the first light emission unit group and a second electrode of the second light emission unit group made common;
a first switching unit connected between a power supply and a third electrode of the first light emission unit group;
a second switching unit connected between the power supply and a fourth electrode of the second light emission unit group; and
at least one capacitor connected to a connection point between the power supply and the first switching unit and second switching unit.

Furthermore, the present technology is a ranging device including:
the illumination device described above;
a control unit that controls the illumination device;
a light reception unit that receives reflection light reflected by a target; and
a ranging unit that calculates a ranging distance from image data obtained by the light reception unit.

### BRIEF DESCRIPTION OF DRAWINGS

FIG. 1 is a block diagram illustrating an example of a schematic configuration of a ranging device including an illumination device according to one embodiment.

FIG. 2 is a schematic cross-sectional view illustrating an example of a schematic configuration of the illumination device according to one embodiment.

FIG. 3A is a diagram illustrating an example of an irradiation pattern at the time of spot irradiation of the illumination device, and FIG. 3B is an enlarged view in a frame of chain line in FIG. 3A.

FIG. 4A is a diagram illustrating another example of the irradiation pattern at the time of spot irradiation of the illumination device, and FIG. 4B is an enlarged view in a frame of chain line in FIG. 4A.

FIG. 5 is a schematic diagram illustrating an example of a diffraction element.

FIG. 6A is a schematic diagram illustrating an irradiation pattern before spot irradiation light emitted from a set of light emission units passes through the diffraction element, and FIG. 6B is a schematic diagram illustrating an irradiation pattern after the spot irradiation light emitted from the set of light emission units passes through the diffraction element.

FIG. 7 is a schematic cross-sectional view illustrating an example of a light emission element according to one embodiment.

FIG. 8 is a schematic cross-sectional view illustrating another example of the light emission element according to one embodiment.

FIG. 9 is a schematic diagram illustrating an example of a planar configuration of the light emission element according to one embodiment.

FIG. 10 is a diagram illustrating an example of a configuration of a drive circuit of the illumination device in a related art.

FIG. 11A is a partially enlarged view of the drive circuit of the illumination device in the related art, and FIG. 11B is an equivalent circuit of the circuit illustrated in FIG. 11A.

FIG. 12A is a diagram illustrating an example of a drive circuit configuration of the illumination device according to one embodiment, and FIG. 12B is a diagram illustrating an example of a pattern in which the circuit configuration illustrated in FIG. 12A is arranged on a substrate.

FIG. 13 is a diagram illustrating another example of the drive circuit configuration of the illumination device according to one embodiment.

FIG. 14 is a diagram illustrating another example of the drive circuit configuration of the illumination device according to one embodiment.

FIG. 15 is a diagram illustrating another example of the drive circuit configuration of the illumination device according to one embodiment.

FIGS. 16A and 16B are diagrams illustrating another example of the drive circuit configuration of the illumination device according to one embodiment.

FIG. 17 is a diagram illustrating another example of the drive circuit configuration of the illumination device according to one embodiment.

FIG. 18A is a diagram illustrating another example of the drive circuit configuration of the illumination device according to one embodiment, and FIG. 18B is a diagram illustrating an example of a pattern in which the circuit configuration illustrated in FIG. 18A is arranged on a substrate.

FIG. 19 is a diagram illustrating another example of the drive circuit configuration of the illumination device according to one embodiment.

FIG. 20A is a diagram illustrating another example of the drive circuit configuration of the illumination device according to one embodiment, and FIG. 20B is a diagram illustrating an example of a pattern in which the circuit configuration illustrated in FIG. 20A is arranged on a substrate.

FIGS. 21A and 21B are diagrams referred to when an effect obtained by the drive circuit configuration of the illumination device according to one embodiment is described.

FIGS. 22A and 22B are diagrams referred to when an effect obtained by the drive circuit configuration of the illumination device according to one embodiment is described.

FIGS. 23A and 23B are diagrams referred to when an effect obtained by the drive circuit configuration of the illumination device according to one embodiment is described.

FIGS. 24A and 24B are diagrams referred to when an effect obtained by the drive circuit configuration of the illumination device according to one embodiment is described.

FIG. 25 is a diagram for explaining a light emission sequence of the illumination device.

FIG. 26A is a schematic plan view illustrating an example of a configuration of a microlens array according to a variation, and FIG. 26B is a schematic diagram illustrating an example of a cross-sectional configuration of the microlens array illustrated in FIG. 26A.

FIG. 27A is a schematic diagram illustrating a position of a light emission unit for spot irradiation with respect to the microlens array illustrated in FIG. 26A, and FIG. 27B is a schematic diagram illustrating a position of a light emission unit for uniform irradiation with respect to the microlens array illustrated in FIG. 26A.

FIG. 28 is a diagram for explaining a beam forming function in the variation.

FIG. 29 is a diagram illustrating an irradiation pattern for a target.

FIG. 30A is a diagram illustrating an irradiation position of light applied from a light emission unit for spot irradiation toward the target and transmitted without being diffracted by a diffraction element, FIG. 30B is a diagram illustrating an example of an irradiation position of light emitted from the light emission unit for spot irradiation and diffracted by the diffraction element, and FIG. 30C is a diagram illustrating an example of an irradiation position of light emitted from a light emission unit for uniform irradiation and diffracted by the diffraction element.

FIG. 31 is a diagram illustrating an example of an irradiation pattern at the time of spot irradiation of the illumination device.

FIG. 32 is a diagram illustrating an example of an irradiation pattern at the time of uniform irradiation of the illumination device.

FIG. 33 is a diagram referred to when a light emission area of each of different light emission units is described.

FIG. 34 is a diagram illustrating an example of how to divide light emission regions.

FIG. 35 is a diagram illustrating an example of how to divide light emission regions.

FIG. 36 is a diagram illustrating an example of how to divide light emission regions.

FIG. 37 is a diagram illustrating an example of how to divide light emission regions.

### MODE FOR CARRYING OUT THE INVENTION

An embodiment and the like of the present technology are hereinafter described with reference to the drawings. Note that, the description will be given in the following order.

### One Embodiment

### <Variation>

Note that, the embodiment and the like hereinafter described are preferred specific examples of the present technology, and the contents of the present technology are not limited to the embodiment and the like.

### One Embodiment

### [Configuration of Ranging Device]

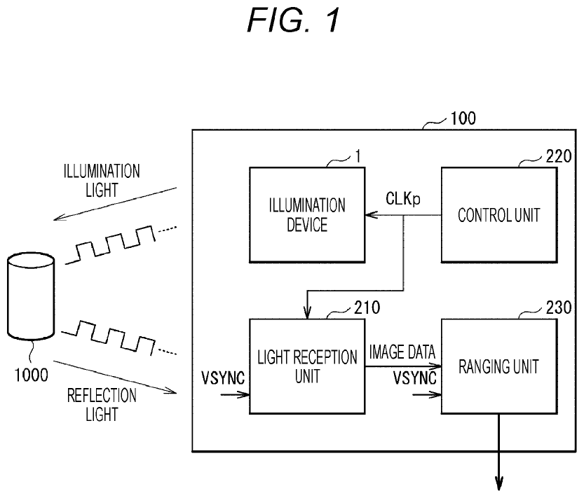

FIG. 1 is a block diagram illustrating an example of an overall configuration of a ranging device 100 according to one embodiment of the present technology.

The ranging device 100 is a device that measures a distance to an irradiation target 1000 by irradiating the irradiation target 1000 with illumination light and receiving reflection light thereof. The ranging device 100 includes an illumination device 1, a light reception unit 210, a control unit 220, and a ranging unit 230.

The illumination device 1 generates irradiation light in synchronization with a light emission control signal CLKp of a rectangular wave from the control unit 220. The light emission control signal CLKp is only required to be a periodic signal, and is not limited to the rectangular wave. For example, the light emission control signal CLKp may be a sine wave.

The light reception unit 210 receives the reflection light reflected from the irradiation target 1000 and detects, each time a period of a vertical synchronization signal VSYNC elapses, an amount of received light within the period. In the light reception unit 210, a plurality of pixel circuits is arranged in a two-dimensional lattice pattern. The light reception unit 210 supplies image data (frame) corresponding to an amount of light received by these pixel circuits to the ranging unit 230. Note that, the light reception unit 210 has a function of correcting a ranging error caused by a multipath, for example.

The control unit 220 controls the illumination device 1 and the light reception unit 210. The control unit 220 generates the light emission control signal CLKp and supplies the same to the illumination device 1 and the light reception unit 210.

The ranging unit 230 measures a distance to the irradiation target 1000 by a ToF method on the basis of the image data. The ranging unit 230 measures the distance for each pixel circuit and generates a depth map indicating a distance to an object as a gradation value for each pixel. This depth map is used for, for example, image processing of performing blurring processing with a degree corresponding to a distance, autofocus (AF) processing of obtaining a focal point of a focus lens according to a distance and the like.

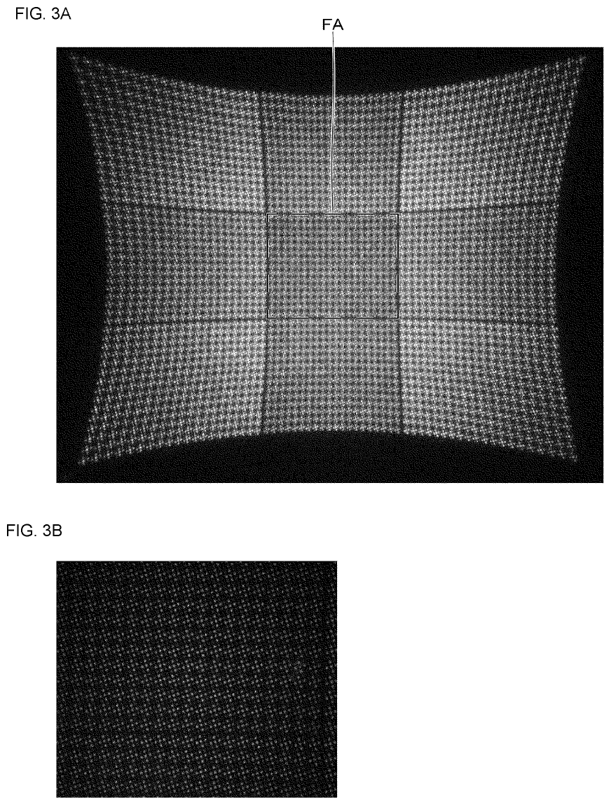

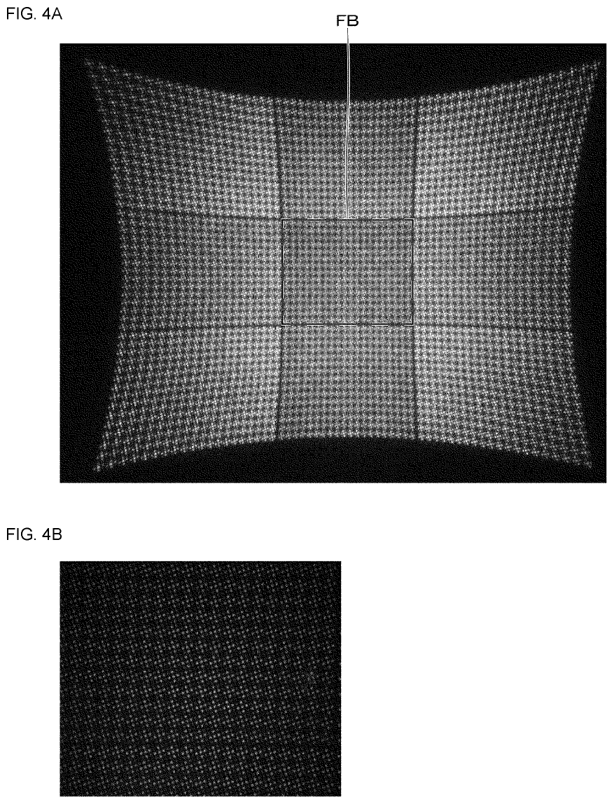

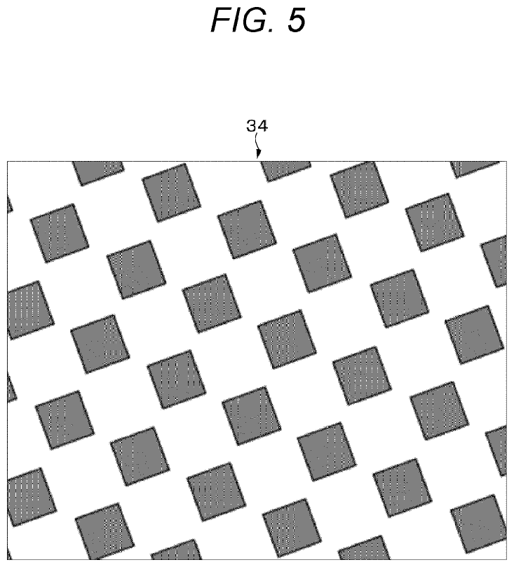

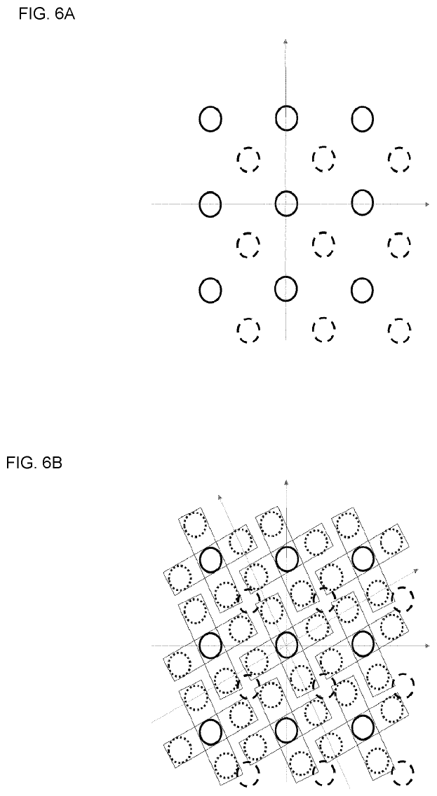

The illumination device 1 according to one embodiment emits light L1 and light L2 from a light emission element 11 including a plurality of light emission units (for example, light emission units 110 and 120 to be described later). Each of the light L1 and the light L2 is, for example, light shaped into a beam shape to be applied as a spot. A diffraction element 14 to be described later is an optical element that tiles the light L1 and the light L2 to widen an irradiation range, and this tiles into 3×3, for example, to widen the irradiation range. FIGS. 3 and 4 illustrate irradiation patterns of two sets of light emission units 110 and 120. An irradiation range of the light L1 is a range within chain line FA illustrated in FIG. 3A (or chain line FB illustrated in FIG. 4A), and an irradiation range of the light L2 is a range around the range within chain line FA illustrated in FIG. 3A (or chain line FB illustrated in FIG. 4A). Each spot of the light L1 and the light L2 diffracted by the diffraction element 14 is further divided (for example, into five parts) by a diffraction element 34 to be described later. As the diffraction element 34, a diffractive optical element (DOE) illustrated in FIG. 5 in which a fine lattice shape is formed on a plane of glass and the like can be used. The diffraction element 34 divides spot irradiation (circle indicated by solid line in FIG. 6A) by one light emission unit illustrated in FIG. 6A into five parts so as to fill a space between the spot irradiations as illustrated in FIG. 6B by generating diffracted light in two directions for each spot.

### [Configuration of Illumination Device]

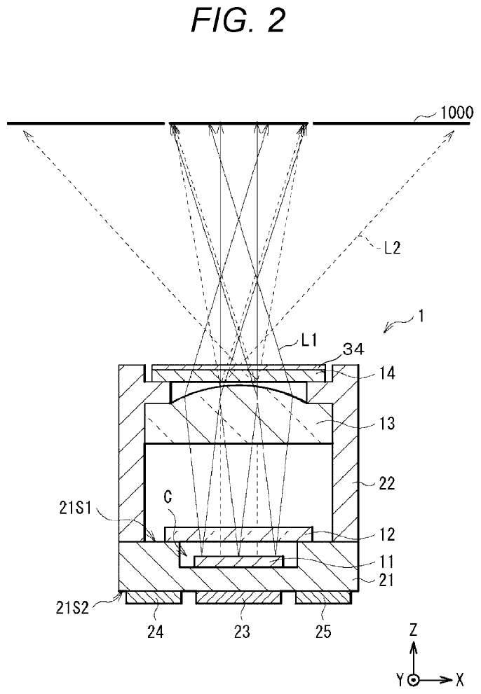

As illustrated in FIG. 2, the illumination device 1 includes, for example, the light emission element 11, a beam shaping unit 12, a collimator lens 13, the diffraction element 14, and the diffraction element 34. The beam shaping unit 12, the collimator lens 13, the diffraction element 14, and the diffraction element 34 are arranged in this order, for example, on an optical path of the light (light L1 and light L2) emitted from the light emission element 11. The light emission element 11 is held by, for example, a holding unit 21, and the collimator lens 13 and the diffraction element 14 are held by, for example, a holding unit 22. The diffraction element 34 is supported by the diffraction element 14 by adhesion and the like. The holding unit 21 includes, for example, one cathode electrode unit 23 and two anode electrode units 24 and 25 on a surface 21S2 on a side opposite to a surface 21S1 holding the light emission element 11, for example. Hereinafter, each member forming the illumination device 1 will be described in detail.

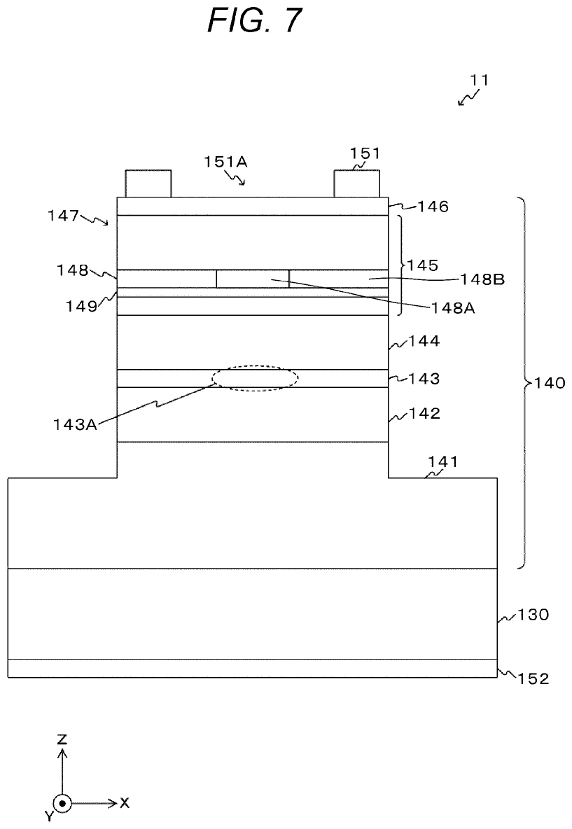

The light emission element 11 is, for example, a surface emitting type surface emitting semiconductor laser. FIG. 7 is a cross-sectional view illustrating a first structural example of the light emission element 11 according to one embodiment of the present technology.

The light emission elements 11 is arranged in an array on a substrate 130. Each of the light emission elements 11 includes a semiconductor layer 140 including a lower distributed Bragg reflector (DBR) layer 141, a lower spacer layer 142, an active layer 143, an upper spacer layer 144, an upper DBR layer 145, and a contact layer 146 in this order on a front surface side of the substrate 130. An upper portion of the semiconductor layer 140, specifically, a part of the lower DBR layer 141, the lower spacer layer 142, the active layer 143, the upper spacer layer 144, the upper DBR layer 145, and the contact layer 146 form a columnar mesa 147. In the mesa 147, the center of the active layer 143 forms a light emission region 143A. Furthermore, the upper DBR layer 145 is provided with a current constriction layer 148 and a buffer layer 149.

The substrate 130 is, for example, an n-type GaAs substrate. Examples of an n-type impurity include, for example, silicon (Si), selenium (Se) or the like. Each semiconductor layer includes, for example, an AlGaAs-based compound semiconductor. The AlGaAs-based compound semiconductor refers to a compound semiconductor containing at least aluminum (Al) and gallium (Ga) among Group 13 elements in the periodic table of elements and at least arsenic (As) among Group 15 elements in the periodic table of elements.

The lower DBR layer 141 is obtained by alternately stacking a low refractive index layer and a high refractive index layer (neither is illustrated). The low refractive index layer is formed by using, for example, n-type Alₓ₁Ga₁₋ₓ₁As (0<x1<1) having a thickness of \grave{λ}₀/4n₁ (λ₀ represents an emission wavelength, and n₁ represents a refractive index). The high refractive index layer is formed by using, for example, n-type Alₓ₂Ga₁₋ₓ₂As (0<x2<x1) having a thickness of λ₀/4n₂ (n2 represents a refractive index).

The lower spacer layer 142 is formed by using, for example, n-type Alₓ₃Ga₁₋ₓ₃As (0<x3<1). The upper spacer layer 144 is formed by using, for example, p-type Alₓ₅Ga₁₋ₓ₅As (0<x5<1). Examples of a p-type impurity include, for example, zinc (Zn), magnesium (Mg), and beryllium (Be) and the like.

The active layer 143 has a multi quantum well (MQW) structure. The active layer 143 has, for example, a structure obtained by alternately stacking a thin film of n-type Alₓ₆Ga₁₋ₓ₆As (0<x6<1) and a tunnel junction layer.

The upper DBR layer 145 is formed by alternately stacking a low refractive index layer and a high refractive index layer (neither is illustrated). The low refractive index layer is formed by using, for example, p-type Alₓ₈Ga₁₋ₓ₈As (0<x8<1) having a thickness of λ₀/4n₃ (n₃ represent a refractive index). The high refractive index layer is formed by using, for example, p-type Alₓ₉Ga₁₋ₓ₉As (0<x9<x8) having a thickness of λ₀/4n₄ (n₄ represent a refractive index). The contact layer 146 is formed by using, for example, p-type Alₓ₁₀Ga₁₋ₓ₁₀As (0<x10<1).

The current constriction layer 148 and the buffer layer 149 are provided in the lower DBR layer 141, for example. The current constriction layer 148 is formed at a position away from the active layer 143 in relation to the buffer layer 149. The current constriction layer 148 is provided, for example, in place of the low refractive index layer in a portion of the low refractive index layer several layers away from the active layer 143 side, for example, in the lower DBR layer 141. The current constriction layer 148 includes a current injection region 148A and a current constriction region 148B. The current injection region 148A is formed in a central region in the plane. The current constriction region 148B is formed on a peripheral edge of the current injection region 148A, that is, an outer edge region of the current constriction layer 148, and has an annular shape.

The current injection region 148A is formed by using, for example, n-type Alₓ₁₁Ga₁₋ₓ₁₁As (0.98≤x11≤1). The current constriction region 148B is formed by containing, for example, aluminum oxide (Al₂O₃), and is obtained by oxidizing an oxidized layer (not illustrated) formed by using, for example, n-type Alₓ₁₁Ga₁₋ₓ₁₁As from a side surface of the mesa 147. Therefore, the current constriction layer 148 has a function of constricting a current.

The buffer layer 149 is formed closer to the active layer 143 in relation to the current constriction layer 148. The buffer layer 149 is formed adjacent to the current constriction layer 148. For example, as illustrated in FIG. 7, the buffer layer 149 is formed in contact with a surface (lower surface) on the active layer 143 side of the current constriction layer 148. Note that, a thin layer having a thickness of, for example, about several nm may be provided between the current constriction layer 148 and the buffer layer 149. The buffer layer 149 is provided, for example, in place of the high refractive index layer in a portion of the high refractive index layer several layers away from the current constriction layer 148 side, for example, in the lower DBR layer 141.

The buffer layer 149 includes an unoxidized region and an oxidized region (neither is illustrated). The unoxidized region is mainly formed in a central region in the plane, and is formed, for example, at a portion in contact with the current injection region 148A. The oxidized region is formed on a peripheral edge of the unoxidized region and has an annular shape. The oxidized region is mainly formed in an outer edge region in the plane, and is formed, for example, in a portion in contact with the current constriction region 148B. The oxidized region is formed to be biased toward the current constriction layer 148 side in a portion other than a portion corresponding to an outer edge of the buffer layer 149.

The unoxidized region is formed by using a semiconductor material containing Al, and is formed by using, for example, n-type Alₓ₁₂Ga₁₋ₓ₁₂As (0.85<x12≤ 0.98) or n-type InₐAlₓ₁₃Ga₁₋ₓ₁₃₋ₐAs (0.85<x13≤0.98). The oxidized region contains, for example, aluminum oxide (Al₂O₃), and is obtained by oxidizing a layer to be oxidized (not illustrated) including, for example, n-type Alₓ₁₂Ga₁₋ₓ₁₂As or n-type In_{b}Alₓ₁₃Ga_{1-x13-b}As from the side surface side and the layer to be oxidized side of the mesa 147. The layer to be oxidized of the buffer layer 149 is formed by using a material and a thickness that have a higher oxidation rate than that of the upper DBR layer 145 and the lower DBR layer 141 and a lower oxidation rate than that of the layer to be oxidized of the current constriction layer 148.

On tan upper surface of the mesa 147 (an upper surface of the contact layer 146), an annular upper electrode 151 including an opening (light emission port 151A) in a region facing at least the current injection region 148A is formed. Furthermore, an insulating layer (not illustrated) is formed on the side surface and a peripheral surface of the mesa 147. The upper electrode 151 is connected to different electrode pads by wire bonding and the like by wiring not illustrated for each light emission unit group. Furthermore, a lower electrode 152 is provided on the other surface of the substrate 130. The lower electrode 152 is electrically connected to, for example, the cathode electrode unit 23. In this manner, one embodiment is an embodiment in which the cathode electrode unit is made a common electrode, and the cathode electrode unit is separately provided.

Here, the upper electrode 151 is formed by, for example, stacking titanium (Ti), platinum (Pt), and gold (Au) in this order, and is electrically connected to the contact layer 146 above the mesa 147. The lower electrode 152 has a structure in which, for example, an alloy of gold (Au) and germanium (Ge), nickel (Ni), and gold (Au) are stacked in this order from the substrate 130 side, and is electrically connected to the substrate 130.

A plurality of light emission units has a configuration in which, for example, a plurality of light emission units (a plurality of light emission units 110 for spot irradiation) used for spot irradiation and a plurality of light emission units (a plurality of light emission units 120 for spot irradiation) used for spot irradiation are arranged in an array on the substrate 130, for example. The plurality of light emission units 110 and the plurality of light emission units 120 are physically and electrically separated from each other by a mesa structure of the mesa 147.

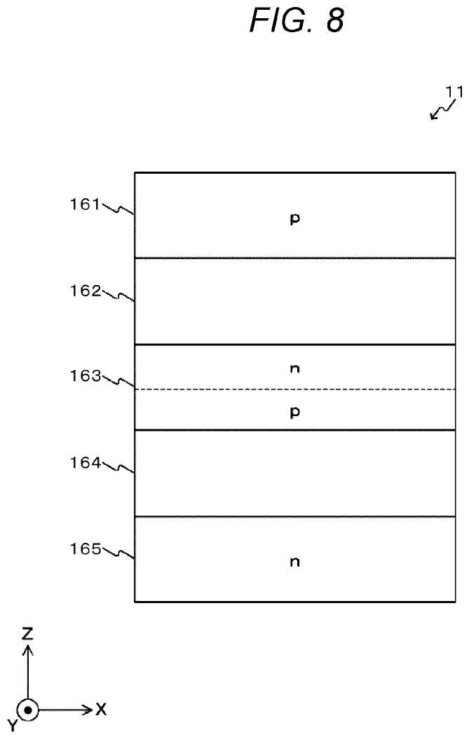

FIG. 8 is a cross-sectional view illustrating a second structural example of the light emission element 11 according to one embodiment of the present technology.

The light emission element 11 of the second configuration example is a multi-junction VCSEL, and has a structure in which a P-DBR layer 161, an active layer 162, a tunnel junction 163, an active layer 164, and an N-DBR layer 165 are stacked in this order from an emission side. That is, two pn junctions are connected, and the active layers (active regions) 162 and 164 that emit a laser oscillation wavelength are stacked between them in a vertical direction. By providing a plurality of active layers 162 and 164 in this manner, an output of the light by each of the light emission elements 11 may be improved (refer to Zhu Wenjun, et al.: “Analysis of the operating point of a novel multiple-active-region tunneling-regenerated vertical-cavity surface-emitting laser”, Proc. of International Conference on Solid-State and Integrated Circuit Technology, Vol. 6, pp. 1306-1309, 2001). According to this multi-junction VCSEL, it is possible to reduce a size and a cost of the element. Note that, although not described in the second structural example, similarly to the first structural example, a spacer layer in the vicinity of an active layer, a buffer layer, a current constriction layer, a mesa, a light emission port, an upper electrode layer, and a lower electrode layer may be provided.

In one embodiment of the present technology, since the spot light is divided by the diffraction element 34, it is possible to increase the number of spots while maintaining or enhancing light intensity of the spot light by combining with the multi-junction VCSEL. Then, therefore, both ranging accuracy and ranging resolution can be satisfied.

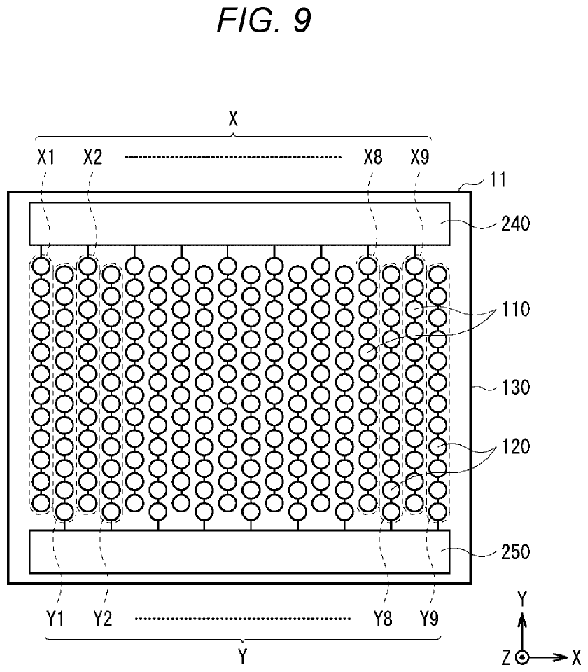

The above-described light emission element 11 includes, for example, the plurality of light emission units 110 and the plurality of light emission units 120. Each of the plurality of light emission units 110 and 120 emits light for spot irradiation. The plurality of light emission units 110 and the plurality of light emission units 120 are electrically connected to each other. Specifically, for example, as illustrated in FIG. 9, the plurality of light emission units 110 forms a plurality of (for example, nine in FIG. 9) light emission unit groups X (light emission unit groups X1 to X9) including n (for example, 12 in FIG. 9) light emission units 110 extending in one direction (for example, in a Y-axis direction). Similarly, the plurality of light emission units 120 forms a plurality of (for example, nine in FIG. 9) light emission unit groups Y (light emission unit groups Y1 to Y9) including m (for example, 12 in FIG. 9) light emission units 120 extending in one direction (for example, in the Y-axis direction). As illustrated in FIG. 9, the light emission unit groups X1 to X9 and the light emission unit groups Y1 to Y9 are alternately arranged on the substrate 130 having a rectangular shape, for example; the light emission unit groups X1 to X9 are electrically connected to, for example, an electrode pad 240 provided along one side of the substrate 130, and the light emission unit groups Y1 to Y9 are electrically connected to, for example, an electrode pad 250 provided along another side facing the one side of the substrate 130. Note that, although FIG. 9 illustrates an example in which the light emission unit groups X1 to X9 and Y1 to Y9 are alternately arranged, there is no limitation. For example, the number of the plurality of light emission units 110 and the number of the plurality of light emission units 120 can be of any array depending on the number and position of desired light emission points and the amount of light output. As an example, the plurality of light emission units 120 may be arrayed in every two columns of the plurality of light emission units 110.

The beam shaping unit 12 is a member having a beam shaping function. As the beam shaping unit 12, for example, a microlens array (MLA), a DOE, a diffuser and the like can be applied. Note that, the beam shaping unit 12 is not necessarily provided.

The collimator lens 13 emits laser beams (hereinafter, appropriately referred to as laser beams L110) emitted from the plurality of light emission units 110 and laser beams (hereinafter, appropriately referred to as laser beams L120) emitted from the plurality of light emission units 120 as substantially parallel light. The collimator lens 13 is, for example, a lens for collimating the laser beam L110 and the laser beam L120 emitted from the light emission units 110 and 120, respectively, and coupling them with the diffraction elements 14 and 34. In this embodiment, both the laser beam L110 and the laser beam L120 are light to be applied as a spot.

The diffraction element 14 divides and emits each of the laser beams L110 emitted from the plurality of light emission units 110 and the laser beams L120 emitted from the plurality of light emission units 120. For example, the diffraction element 14 divides the laser beams L110 emitted from the plurality of light emission units 110 and the laser beams L120 emitted from the plurality of light emission units 120 into 3×3. By arranging the diffraction element 14, it is possible to tile light fluxes of the laser beams L110 and the laser beams L120, for example, to increase the irradiation range. Moreover, by arranging the diffraction element 34, each spot of the laser beams L110 and L120 to be applied as a spot can be divided into, for example, five parts, and the number of spots at the time of spot irradiation can be increased.

The holding unit 21 and the holding unit 22 are for holding the light emission element 11, the collimator lens 13, and the diffraction element 14. Specifically, the holding unit 21 holds the light emission element 11 in a recess C provided on an upper surface (surface 21S1) (refer to FIG. 2). The holding unit 22 holds the collimator lens 13 and the diffraction element 14. The holding unit 21 and the holding unit 22 are connected to each other in such a manner that the light L1 and the light L2 emitted from the light emission element 11 are incident on the collimator lens 13, and the light L1 and the light L2 transmitted through the collimator lens 13 become substantially parallel light.

A plurality of electrode units is provided on a back surface (surface 21S2) of the holding unit 21. Specifically, the cathode electrode unit 23 common to the plurality of light emission units 110 for spot irradiation and the plurality of light emission units 120 for spot irradiation, the anode electrode unit 24 of the plurality of light emission units 110 for spot irradiation, and the anode electrode unit 25 of the plurality of light emission units 120 for spot irradiation are provided on the surface 21S2 of the holding unit 21.

Note that, the configuration of the plurality of electrode units provided on the surface 21S2 of the holding unit 21 is not limited to the above, and for example, the cathode electrode units of the plurality of light emission units 110 for spot irradiation and the plurality of light emission units 120 for spot irradiation may be separately formed, or the anode electrode units of the plurality of light emission units 110 for spot irradiation and the plurality of light emission units 120 for spot irradiation may be formed as the common electrode unit. Furthermore, the collimator lens 13 and the diffraction element 14 may be held by the holding unit 21.

### [Drive Circuit of Illumination Device]

### Example of Drive Circuit

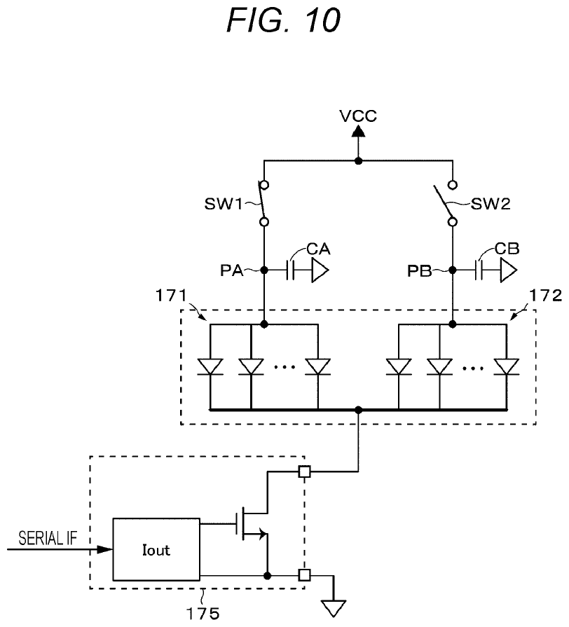

Next, a drive circuit of the illumination device 1 is described. Note that, in order to facilitate understanding of the present technology, first, a circuit configuration considered as a drive circuit that drives the illumination device 1 will be described with reference to FIG. 10. As illustrated in the drawing, cathodes of a first light emission unit group 171 and a second light emission unit group 172 are connected to a power supply (VCC) such as a constant voltage power supply. Here, the first light emission unit group 171 is, for example, a set of light emission units 110 connected to the electrode pad 240. Furthermore, the second light emission unit group 172 is, for example, a set of light emission units 120 connected to the electrode pad 250.

A common cathode of the first light emission unit group 171 and the second light emission unit group 172 is connected to a laser driver 175. The first light emission unit group 171 and the second light emission unit group 172 selectively emit light by the laser driver 175. The first light emission unit group 171 or the second light emission unit group 172 that is caused to emit light is selected by opening and closing a first switching unit SW1 and a second switching unit SW2. That is, the light emission of the light emission unit group (first light emission unit group 171) connected to an X side and the light emission of the light emission unit group (second light emission unit group 172) connected to a Y side can be switched by complementary drive control in which one of the two switching units is turned on and the other is turned off. In other words, the first light emission unit group 171 (one channel) and the second light emission unit group 172 (the other channel) can be individually driven.

The first switching unit SW1 is connected between the power supply and an anode of the first light emission unit group 171. The second switching unit SW2 is connected between the power supply and an anode of the second light emission unit group 172. Here, a decoupling capacitor CA is connected to a position close to the first light emission unit group 171, specifically, a connection point PA between the first light emission unit group 171 and the first switching unit SW1. The other end of the decoupling capacitor CA is connected to the ground. Furthermore, a decoupling capacitor CB is connected to a position close to the second light emission unit group 172, specifically, a connection point PB between the second light emission unit group 172 and the second switching unit SW2. The other end of the decoupling capacitor CB is connected to the ground. With this configuration, charge accumulated in the decoupling capacitor CA can be supplied to the light emission unit 110 forming the first light emission unit group 171 in a short time, and charge accumulated in the decoupling capacitor CB can be supplied to the light emission unit 120 forming the second light emission unit group 172 in a short time. That is, in the illumination device 1, modulation of a large current with high responsiveness can be implemented.

However, in the configuration illustrated in FIG. 10, there is a problem that a series resonant circuit (LC series resonant circuit) as illustrated in an equivalent circuit in FIG. 11B is formed with the off-side light emission unit (for example, the light emission unit 120 forming the second light emission unit group 172) and the decoupling capacitor CB as elements having capacitance (C) and wiring by wire bonding as an element having inductance (L) as illustrated in FIG. 11A, and frequency characteristics deteriorate. The same applies to a case where the first switching unit SW1 is turned off.

Therefore, in this embodiment, a circuit configuration illustrated in FIG. 12A is adopted. Note that, redundant description of the configuration similar to that in FIG. 10A will be omitted as appropriate.

A cathode (an example of a first electrode) of the first light emission unit group 171 and a cathode (an example of a second electrode) of the second light emission unit group 172, that is, the common cathode, are connected to the laser driver (drive unit) 175. The first light emission unit group 171 and the second light emission unit group 172 selectively emit light by the laser driver 175. For example, a N-type metal oxide semiconductor field effect transistor (MOSFET) can be applied to the laser driver 175, but this may also be a P-type MOSFET and a bipolar transistor. At a timing when the laser driver 175 is turned on, a current flows through the light emission unit group corresponding to the switching unit that is turned on, and light emission occurs. The first light emission unit group 171 or the second light emission unit group 172 that is caused to emit light is selected by opening and closing the first switching unit SW1 and the second switching unit SW2. That is, the light emission of the light emission unit group (first light emission unit group 171) connected to an X side and the light emission of the light emission unit group (second light emission unit group 172) connected to a Y side can be switched by complementary drive control in which one of the two switching units is turned on and the other is turned off.

The first switching unit SW1 is connected between the power supply and the anode of the first light emission unit group 171 (an example of a third electrode). The second switching unit is connected between the power supply and the anode of the second light emission unit group 172 (an example of a fourth electrode). A load switch can be applied as the first switching unit SW1 and the second switching unit SW2.

The drive circuit of the illumination device 1 includes at least one capacitor connected between the power supply and the first switching unit and the second switching unit. For example, as illustrated in FIG. 12A, the drive circuit of the illumination device 1 includes a decoupling capacitor C1 (an example of a first capacitor) connected to a connection point PC between the power supply and the first switching unit SW1, and a decoupling capacitor C2 (an example of a second capacitor) connected to a connection point PD between the power supply and the second switching unit SW2. Note that, the connection point can be set at any site. The other end of the decoupling capacitor C1 is connected to the ground. Furthermore, the other end of the decoupling capacitor C2 is connected to the ground. In this manner, in the drive circuit in this example, the connection position of the decoupling capacitor is different from that of the drive circuit illustrated in FIG. 10A.

FIG. 12B illustrates an image when the circuit configuration illustrated in FIG. 12A is mounted on a substrate. Note that, a round configuration in FIG. 12B indicates the collimator lens 13 (the same applies to FIG. 20B). It goes without saying that the arrangement of the circuit configuration is not limited to the example illustrated in FIG. 12B.

According to the configuration according to this embodiment, the decoupling capacitor C2 of a channel in an off-state (in the example illustrated in FIG. 12A, the second light emission unit group 172) is electrically disconnected, so that impedance of the channel on a side on which the switching unit is turned off increases. Therefore, an influence of the series resonant circuit formed at the time of driving at a high frequency, which occurs in the circuit configuration illustrated in FIG. 10A, can be reduced, and the frequency characteristics can be improved.

### Another Example of Drive Circuit

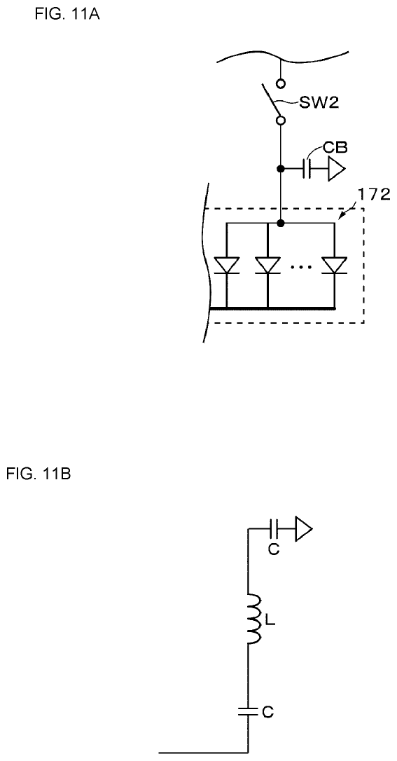

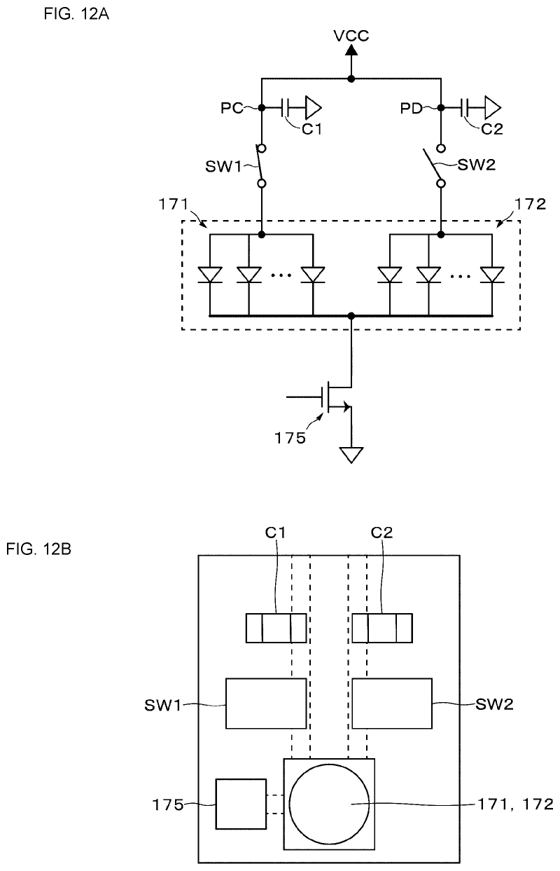

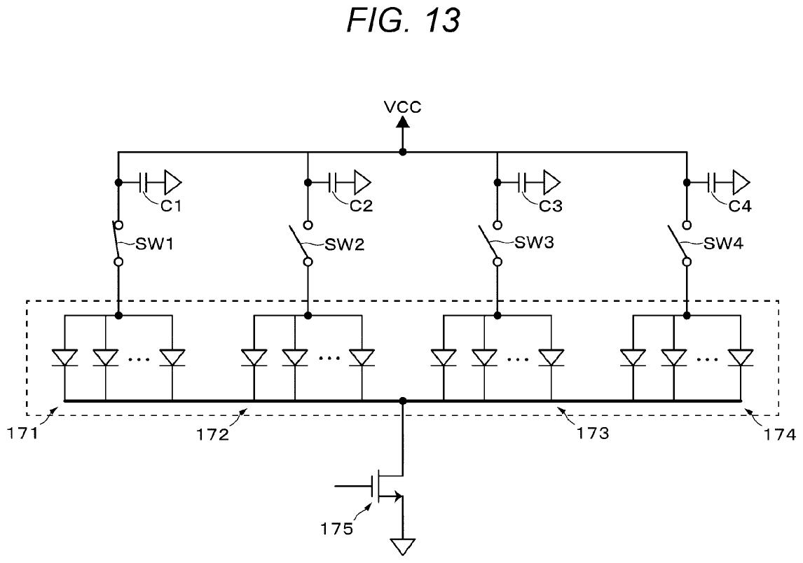

The drive circuit of the illumination device 1 is not limited to the circuit configuration illustrated in FIG. 12A. The circuit configuration illustrated in FIG. 12A includes two light emission unit groups, but may include three or more light emission unit groups. For example, the drive circuit of the illumination device 1 may have a circuit configuration including four light emission unit groups (171 to 174) as illustrated in FIG. 13. Also in this case, one end of each of the decoupling capacitors C1 to C4 is connected to the connection point between the power supply and each light emission unit group. The other end of each of the decoupling capacitors C1 to C4 is connected to the ground.

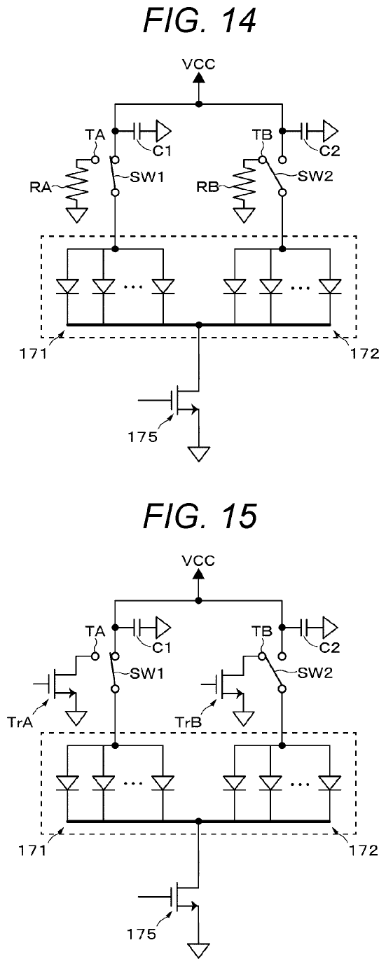

As illustrated in FIG. 14, the drive circuit of the illumination device 1 may have a configuration in which a resistor RA is connected to an off-side terminal TA of the first switching unit SW1 and a resistor RA is connected to an off-side terminal TB of the second switching unit SW2. The other end of each of the resistors RA and RB is connected to the ground. By providing the resistors RA and RB, an effect of damping the series resonant circuit formed in the off-side channel is obtained, and excellent frequency characteristics are obtained. As illustrated in FIG. 15, transistors TrA and TrB may be connected to the off-side terminals TA and TB instead of resistors. As the transistors TrA and TrB, for example, an N-type MOSFET is used. Such circuit configuration also has an effect of damping the series resonant circuit formed in the off-side channel by on-resistor of the transistors TrA and TrB, and excellent frequency characteristics can be obtained.

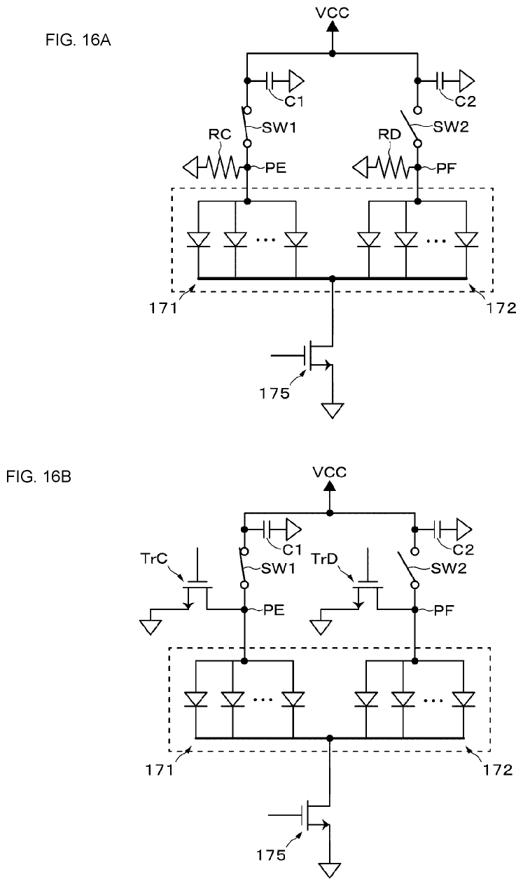

Furthermore, as illustrated in FIG. 16A, one end of a resistor RC may be connected to a connection point PE between the first switching unit SW1 and the anode of the first light emission unit group 171, and one end of a resistor RD may be connected to a connection point PF between the second switching unit SW2 and the anode of the second light emission unit group 172. The other end of each of the resistors RC and RD is connected to the ground. By such configuration, an effect of damping the series resonant circuit formed in the off-side channel is obtained, and excellent frequency characteristics are obtained. Note that, as illustrated in FIG. 16B, the resistors RC and RD may be transistors TrC and TrD. As the transistors TrC and TrD, for example, an N-type MOSFET is used. Such circuit configuration also has an effect of damping the series resonant circuit formed in the off-side channel by on-resistor of the transistors TrC and TrD, and excellent frequency characteristics can be obtained.

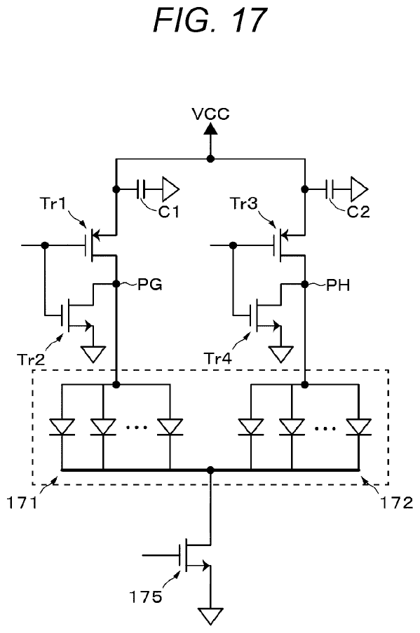

In the drive circuit of the illumination device 1, the first switching unit SW1 and the second switching unit SW2 may be transistors instead of load switches. For example, as illustrated in FIG. 17, the first switching unit SW1 may be a transistor Tr1, and the second switching unit SW2 may be a transistor Tr3. As the transistors Tr1 and Tr3, for example, a P-type MOSFET is used and is driven complementarily. Furthermore, a transistor Tr2 is connected between the transistor Tr1 and the anode of the first light emission unit group 171, and a transistor Tr4 is connected between the transistor Tr3 and the anode of the second light emission unit group 172. As the transistors Tr2 and Tr4, for example, an N-type MOSFET is used.

A source of the transistor Tr1 is connected to the power supply, and a drain thereof is connected to the anode of the first light emission unit group 171. A drain of the transistor Tr2 is connected to a connection point PG between the drain of the transistor Tr1 and the anode of the first light emission unit group 171. A source of the transistor Tr2 is connected to the ground. The decoupling capacitor C1 is connected between the transistor Tr1 and the power supply. The same signal is input to gates of the transistor Tr1 and the transistor Tr2. In this example, since the transistor Tr1 and the transistor Tr2 are different types of MOSFETs, the transistor Tr1 and the transistor Tr2 are driven complementarily. When the transistor Tr1 is turned off, the transistor Tr2 is turned on, and the on-resistor of the transistor Tr2 functions as a damping resistor, whereby the influence of the series resonant circuit formed when the transistor Tr1 is turned off can be reduced, and the frequency characteristics can be improved.

A source of the transistor Tr3 is connected to the power supply, and a drain thereof is connected to the anode of the second light emission unit group 172. A drain of the transistor Tr4 is connected to a connection point PH between the drain of the transistor Tr2 and the anode of the second light emission unit group 172. A source of the transistor Tr4 is connected to the ground. The decoupling capacitor C2 is connected between the transistor Tr3 and the power supply. The same signal is input to the gates of the transistor Tr3 and the transistor Tr4. In this example, since the transistor Tr3 and the transistor Tr4 are different types of MOSFETs, the transistor Tr3 and the transistor Tr4 are driven complementarily. When the transistor Tr3 is turned off, the transistor Tr4 is turned on, and the on-resistor of the transistor Tr4 functions as a damping resistor, whereby the influence of the series resonant circuit formed when the transistor Tr3 is turned off can be reduced, and the frequency characteristics can be improved.

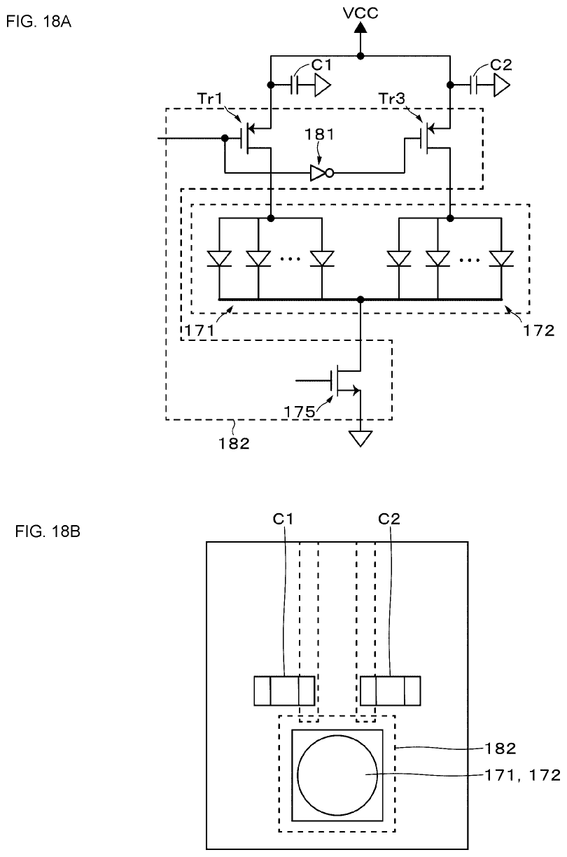

As illustrated in FIG. 18, the drive circuit of the illumination device 1 may have a configuration in which the transistors Tr2 and Tr4 are not provided in the circuit illustrated in FIG. 17. In the circuit configuration illustrated in FIG. 18, signals at different levels are supplied to the gates of the transistors Tr1 and Tr3 via an inversion circuit 181. Therefore, the transistors Tr1 and Tr3 are complementarily driven. Note that, in the example illustrated in FIG. 18, the circuit configuration has a function of the load switch, so that the circuit configuration can be simplified. For example, the configurations of the transistors Tr1 and Tr3, the inversion circuit 181, and the laser driver 175 can be configured as one integrated circuit 182. FIG. 18B illustrates an image when the circuit configuration illustrated in FIG. 18A is mounted on a substrate. The configurations of the transistors Tr1 and Tr3, the inversion circuit 181, and the laser driver 175 can be configured as one integrated circuit 182, so that space saving on the substrate may be implemented.

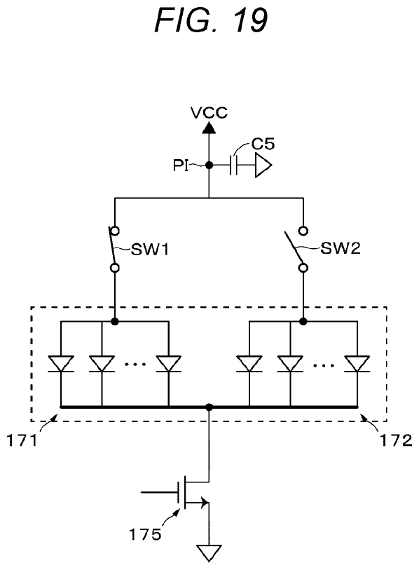

In the plurality of circuit configuration examples described above, the decoupling capacitor corresponding to each light emission unit group is provided, but there is no limitation. For example, as illustrated in FIG. 19, one decoupling capacitor C5 may be connected to a connection point P1 between the power supply and the first switching unit SW1 and second switching unit SW2. The other end of the decoupling capacitor C5 is connected to the ground. By commonizing the plurality of decoupling capacitors, it is possible to reduce the number of components, reduce costs associated with this, and save space in mounting.

Furthermore, a plurality of (for example, two) light emission elements 11 may be provided. FIG. 20A illustrates a circuit configuration in a case where the light emission element 11 is a plurality of light emission elements. The example illustrated in FIG. 20A is an example in which the light emission element including the first light emission unit group 171 is different from the light emission element including the second light emission unit group 172. FIG. 20B illustrates an image when the circuit configuration illustrated in FIG. 20A is mounted on a substrate.

The circuit configuration examples of the drive circuit of the illumination device 1 described above are not necessarily independent from each other, and may be combined. For example, in the circuit configuration illustrated in FIGS. 14 and 15 (the circuit configuration in which the resistor or a transistor is connected to the off-side terminal TA), a resistor or a transistor (refer to FIGS. 16A and 16B) may be connected to a connection point between the switching unit and the anode of the light emission unit group.

### Effects Obtained by Circuit Configuration in This Embodiment

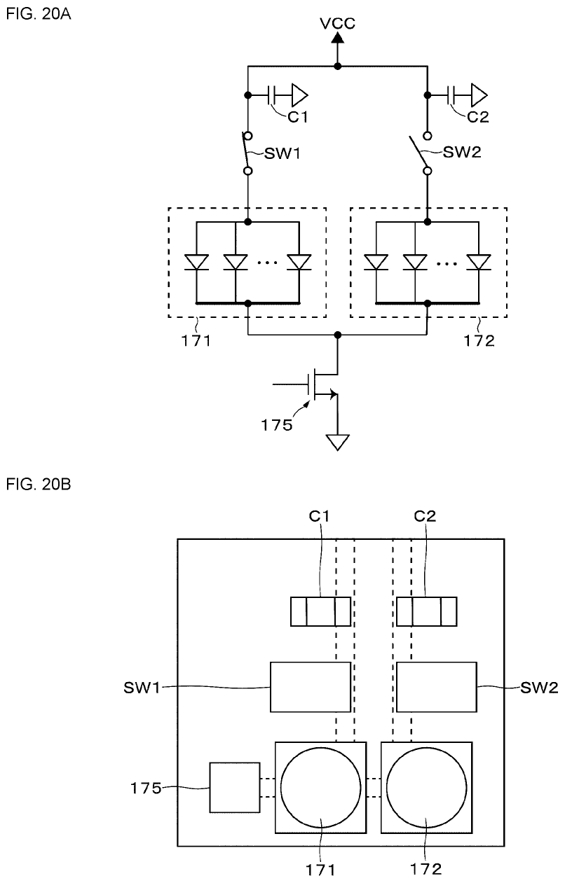

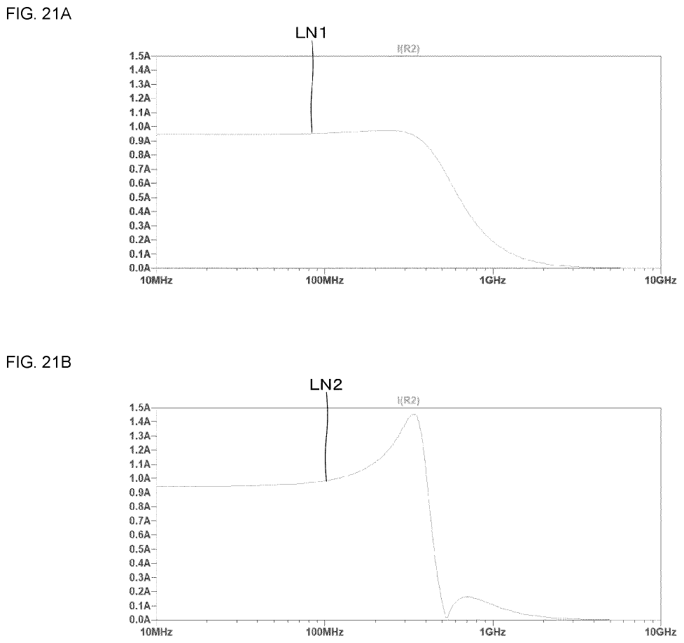

Effects obtained by the circuit configuration of the drive circuit of the illumination device 1 according to this embodiment will be described with reference to FIGS. 21 to 24. In each of FIGS. 21 to 24, a frequency value is plotted along the abscissa, and a current value is plotted along the ordinate. Furthermore, the circuit configuration in this example means the circuit configuration illustrated in FIG. 12A, and the circuit configuration in the related art means the circuit configuration illustrated in FIG. 10A. In each circuit configuration, simulation was performed with capacitance of the decoupling capacitor set to 1 μF, an inductance component of the wiring set to 0.3 nH, and capacitance of each light emission unit group set to 0.3 nF.

FIG. 21A is a graph illustrating a current flowing through an on-side light emission unit group (light emission unit group connected to a turned-on switching unit) in the circuit configuration in this example. Furthermore, FIG. 21B is a graph illustrating a current flowing through an on-side light emission unit group (light emission unit group connected to a turned-on switching unit) in the circuit configuration in the related art.

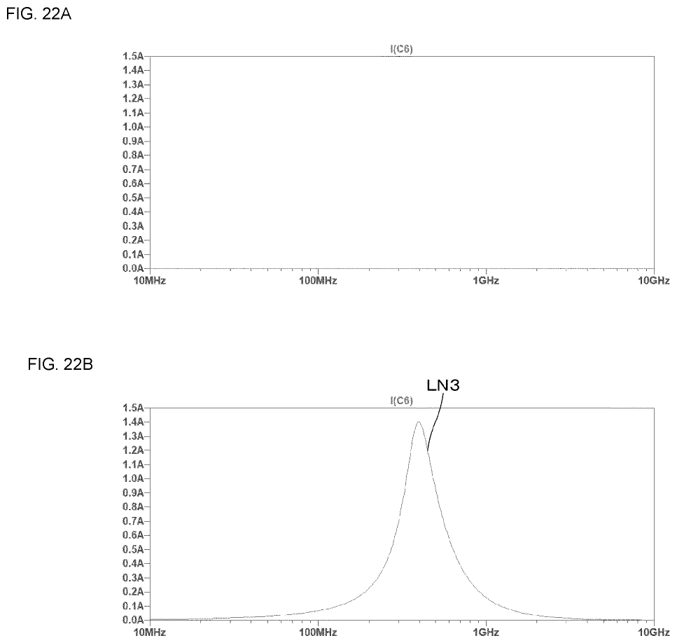

FIG. 22A is a graph illustrating a current flowing through an off-side light emission unit group (light emission unit group connected to a turned-off switching unit) in the circuit configuration in this example. Furthermore, FIG. 22B is a graph illustrating a current flowing through an off-side light emission unit group (light emission unit group connected to a turned-off switching unit) in the related art.

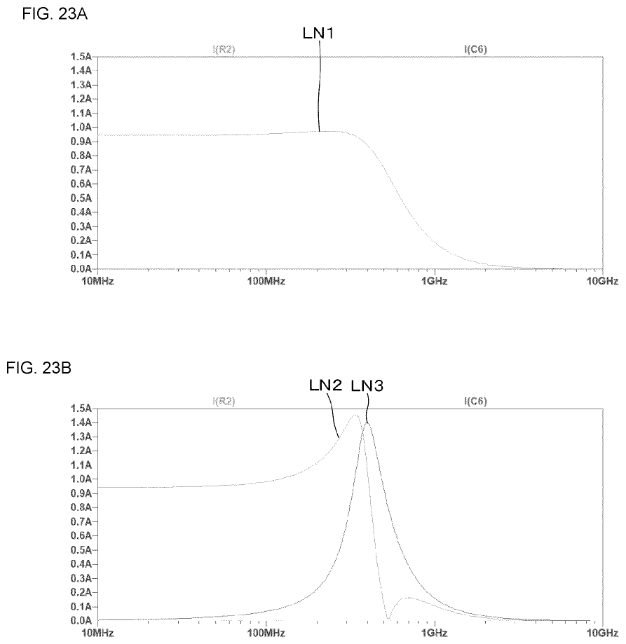

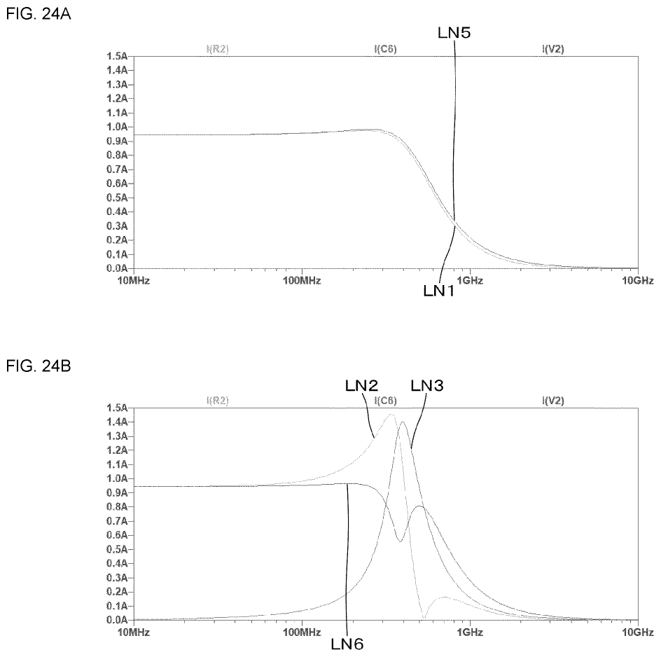

FIG. 23A is a graph illustrating both a result of FIG. 21A and a result of FIG. 22A. Furthermore, FIG. 23B is a graph illustrating both a result of FIG. 21B and a result of FIG. 22B.

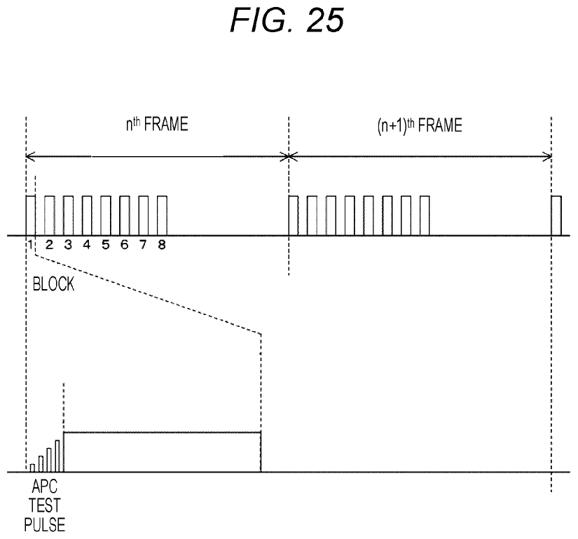

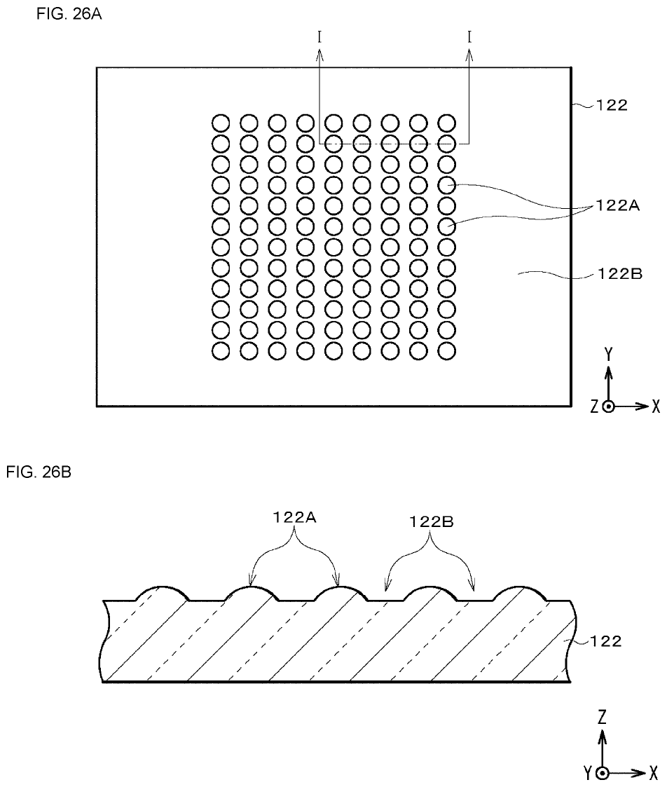

FIG. 24A is a graph in which the current flowing through the laser driver 175 of this example is included in the graph illustrated in FIG. 23A. FIG. 24B is a graph in which the current flowing through the laser driver 175 of the related art is included in the graph illustrated in FIG. 23B.

In the circuit configuration in the related art, as indicated by line LN2 in FIGS. 21B and 23B, it can be seen that a current having a peak (about 1.4 A) at a resonance frequency (around 400 MHz in this example) and sharply decreasing flows through the on-side light emission unit group, and the frequency characteristics are deteriorated. Furthermore, in the circuit configuration in the related art, as indicated by line LN3 in FIGS. 22B and 23B, it can be seen that a current flows through the off-side light emission unit group around the resonance frequency, and the frequency characteristics are deteriorated. When the current also flows through the off-side light emission unit group, there is a possibility that the off-side light emission unit group emits light, and this eventually deteriorates ranging accuracy. In contrast, in the circuit configuration of this example, as indicated by line LN1 in FIGS. 21A and 23A, a change in current as in line LN2 is not observed, and as illustrated in FIGS. 22A and 23A, a current does not flow to the off-side light emission unit group in the vicinity of the resonance frequency, and excellent frequency characteristics are obtained, and it can be seen that electrical separation can be implemented.

In the circuit configuration in the related art, as indicated by line LN6 in FIG. 24B, it can be seen that a current flows through the off-side light emission unit group, so that the current flowing through the laser driver 175 decreases and the frequency characteristics are deteriorated. In contrast, as indicated by line LN5 in FIG. 24A, in the circuit configuration in this embodiment, no fluctuation in the current flowing through the laser driver 175 is observed, and excellent frequency characteristics are obtained.

From above, it has been confirmed that the circuit configuration in this embodiment is superior to the circuit configuration in the related art.

### [Method of Driving Illumination Device]

Next, an example of a method of driving the illumination device 1 is described. FIG. 25 illustrates an example of a light emission sequence of the illumination device 1. A section in which one ranging image is generated is referred to as a “frame”, and one frame is set to, for example, a time of 33.3 msec (frequency of 30 Hz). As a ranging pulse, for example, a rectangular continuous wave of 100 MHz/Duty=50% is used, and this causes continuous light emission between accumulation sections. A plurality of the accumulation sections with different conditions can be provided in the frame. Although eight accumulation sections are illustrated in FIG. 25, the number is not limited to this number.

As illustrated in the drawing, in the illumination device 1, the first light emission unit group 171 is caused to emit light in one frame, and the light reception unit 210 (refer to FIG. 1) receives the reflection light and generates a ranging image. In a next frame, the second light emission unit group 172 is caused to emit light, and the light reception unit 210 receives reflection light to generate a ranging image. Note that, in FIG. 25, the first light emission unit group 171 and the second light emission unit group 172 are switched in each frame, but they may be switched in every plurality of frames. Note that, light emission of the first light emission unit group 171 and the second light emission unit group 172 may be switched, for example, in units of one frame, in units of blocks, or in units of a plurality of blocks. Therefore, for example, it is possible to switch between two sets of spot irradiation at a faster speed as compared with a method of mechanically switching focal positions of laser beams emitted from a plurality of the light emission units.

### <Variation>

Although the embodiments of the present technology are heretofore described specifically, the contents of the present technology are not limited to the above-described embodiments, and various modifications based on the technical idea of the present technology may be made. Note that, configurations identical or similar to those of the embodiment are denoted by the same reference numerals, and redundant description will be omitted as appropriate.

The beam shaping unit 12 may be, for example, a microlens array. The beam shaping unit 12, which is the microlens array (an example of a second optical member and is hereinafter appropriately referred to as a microlens array 122), is arranged on a preceding stage of the collimator lens 13 (an example of a first optical member), for example, on optical paths of the laser beams L110 and the laser beams L120 emitted from the plurality of light emission units 110 and the plurality of light emission units 120, respectively. In this variation, the laser beam L110 is light to be applied as a spot, and the laser beam L120 is light to be applied uniformly.

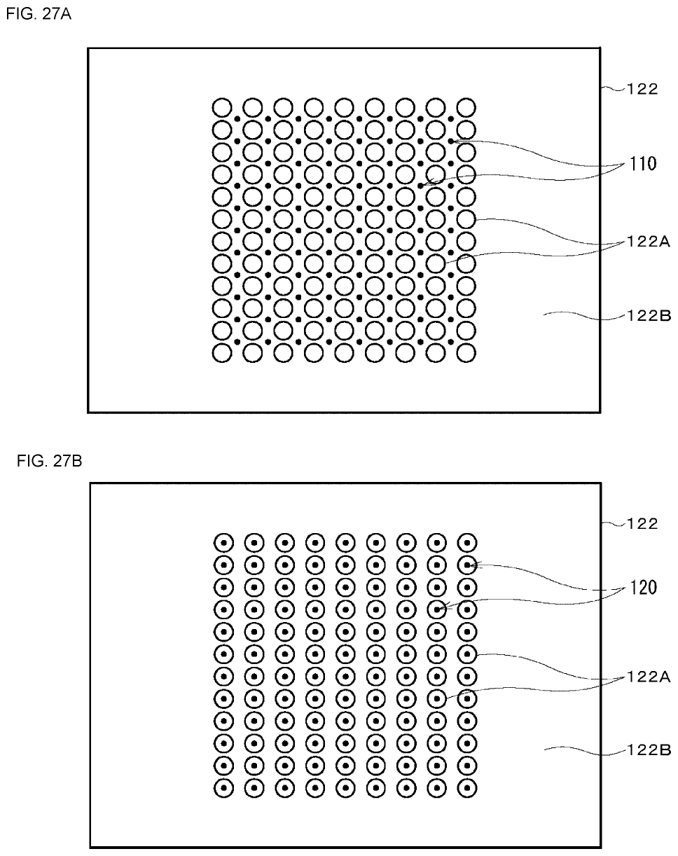

For example, the microlens array 122 forms a beam shape of at least one of light (laser beam L110 or laser beam L120) emitted from the plurality of the light emission units 110 for spot irradiation and the plurality of the light emission units 120 for uniform irradiation to emit. FIG. 26A schematically illustrates an example of a planar configuration of the microlens array 122, and FIG. 26B schematically illustrates a cross-sectional configuration of the microlens array 122 taken along line I-I in FIG. 26A. In the microlens array 122, a plurality of microlenses is arranged in an array, and this includes a plurality of lens units 122A and a parallel planar plate 122B.

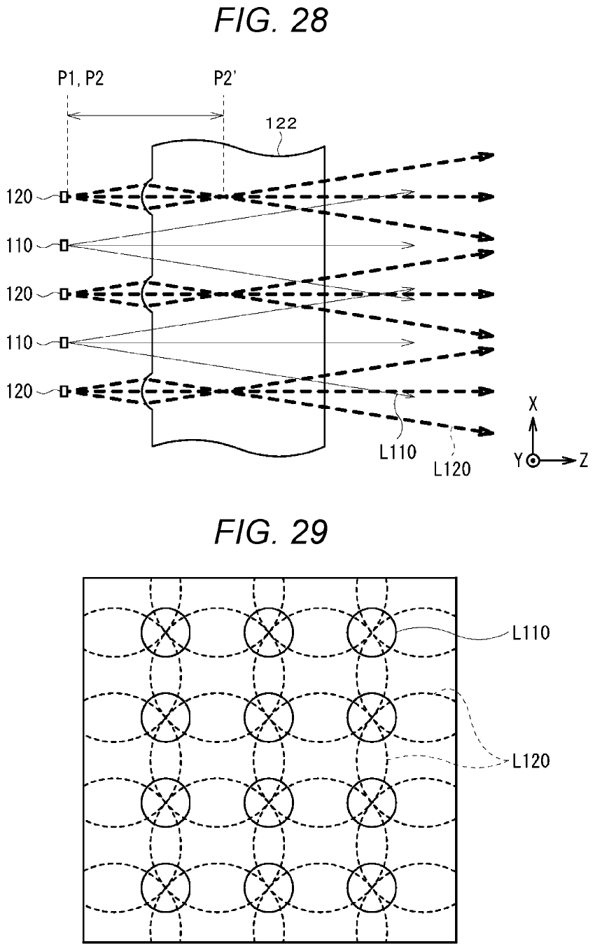

In the microlens array 122, as illustrated in FIG. 27A, the parallel planar plate 122B is arranged so as to directly face the plurality of light emission units 110 for spot irradiation. Furthermore, as illustrated in FIG. 27B, the lens unit 122A is arranged to so as to directly face the plurality of light emission units 120 for uniform irradiation. Therefore, as illustrated in FIG. 28, each of the laser beams L120 emitted from the plurality of the light emission units 120 is refracted by a lens surface of each of the lens units 122A, and for example, forms a virtual light emission point P2′ in the microlens array 122. That is, a light emission point P2 of each of the plurality of light emission units 120 at the same height as a light emission point P1 of each of the plurality of light emission units 110 is shifted in an optical axis direction (for example, in a Z-axis direction) of the light (the laser beams L110 and the laser beams L120) emitted from the plurality of light emission units 110 and the plurality of light emission units 120.

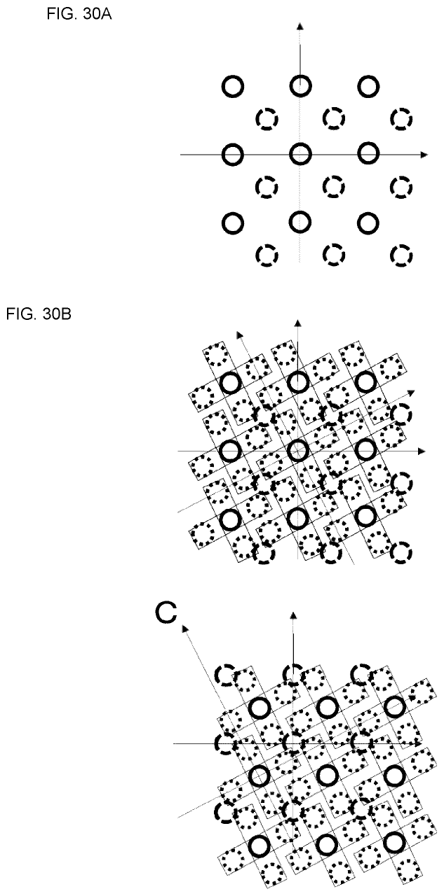

Therefore, by switching the light emission of the plurality of light emission units 110 and the plurality of light emission units 120, the laser beams L110 emitted from the plurality of light emission units 110 pass through the microlens array 122 as they are (without being refracted), and form a spot-shaped irradiation pattern as illustrated in FIG. 29, for example. Furthermore, the laser beams L120 emitted from the plurality of light emission units 120 are refracted by the microlens array 122, and overlap with the laser beams L120 emitted from partially adjacent light emission units 120 as illustrated in FIG. 29, for example, thereby forming an irradiation pattern for irradiating a predetermined range with substantially uniform light intensity. In the illumination device 1, by switching between the light emission of the plurality of light emission units 110 and the light emission of the plurality of light emission units 120, it becomes possible to switch between spot irradiation and uniform irradiation.

Note that, FIG. 28 illustrates an example in which the microlens array 122 functions as a relay lens, but there is no limitation. For example, the virtual light emission point P2′ of the plurality of light emission units 120 may be formed between the light emission unit 120 and the microlens array 122.

The diffraction element 34 (an example of a third optical member) divides and emits the laser beams L110 emitted from the plurality of light emission units 110 and the laser beams L120 emitted from the plurality of light emission units 120. In this variation, for example, light is divided into five parts by the diffraction element 34. In this case, as the diffraction element 34, a diffractive optical element (DOE) illustrated in FIG. 5 in which a fine lattice shape is formed on a plane of glass and the like can be used. Therefore, the diffraction element 34 generates diffracted light in two directions for the irradiation pattern of the diffraction element 14 described above.

FIG. 30A illustrates an irradiation pattern of the laser beam L110 for spot irradiation transmitted through the diffraction element 34 as it is and emitted from the plurality of light emission units 110. FIG. 30A further illustrates an irradiation pattern of the laser beam L120 that is not yet subjected to beam shaping; the irradiation pattern of the laser beam L110 is indicated by solid line, and the irradiation pattern of the laser beam L120 is indicated by dotted line.

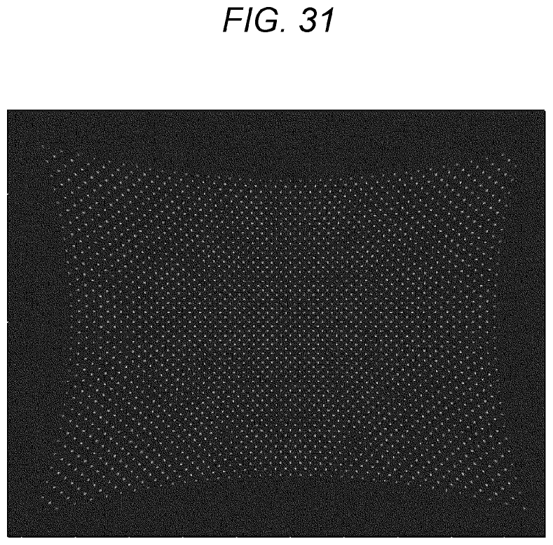

FIG. 30B illustrates an example in which the laser beam L120 is a laser beam for spot irradiation. As illustrated in FIG. 30B, by arranging the diffraction element 34, 0th-order light of the laser beam L120 transmitted through the diffraction element 34 is applied to an irradiation position of the laser beam L120 in a case where the diffraction element 34 is not arranged, and +1st-order light and −1st-order light diffracted by the diffraction element 34 are applied to a position close to the 0th-order light. That is, by arranging the diffraction element 34, the number of light spots with which the irradiation target 1000 is irradiated can be further increased. FIG. 31 illustrates an irradiation pattern (corresponding to FIG. 30B) of the laser beams L120 emitted from the plurality of light emission units 120 with which the irradiation target 1000 is irradiated in a case where the diffraction element 34 is arranged.

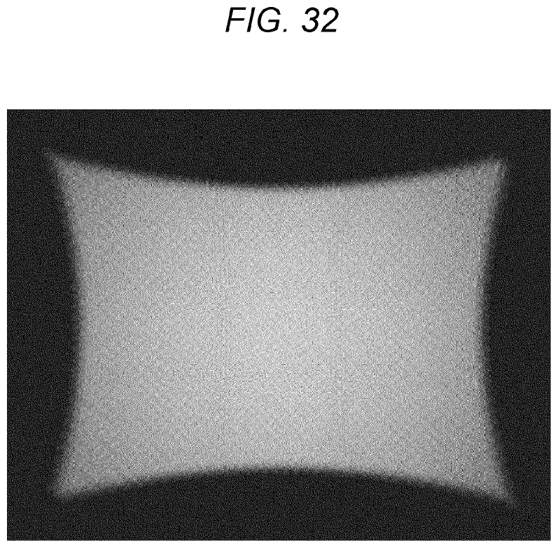

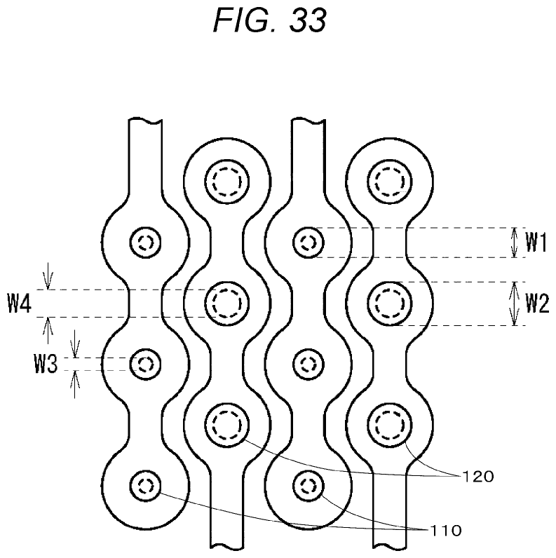

FIG. 30C illustrates an example in which the laser beam L120 is a laser beam for uniform irradiation. As illustrated in FIG. 30C, by arranging the diffraction element 34, 0th-order light of the laser beam L120 transmitted through the diffraction element 34 is applied to an irradiation position of the laser beam L120 in a case where the diffraction element 34 is not arranged, and +1st-order light and −1st-order light are applied to a position close to the 0th-order light. FIG. 32 illustrates an irradiation pattern (corresponding to FIG. 30C) of the laser beams L120 emitted from the plurality of light emission units 120 with which the irradiation target 1000 is irradiated in a case where the diffraction element 34 is arranged. By combining the laser beam L110 in FIG. 30A and the laser beam L120 in FIG. 30C, it is possible to switch and emit light for spot irradiation and light for uniform irradiation. Since the laser beams L120 for uniform irradiation emitted from the plurality of light emission units 120 are diffracted, uniformity of the light intensity at the time of uniform irradiation can be further improved by overlapping of the diffracted light.

As described above, in this variation, the diffraction element 34 is further arranged on the optical paths of the laser beams L110 and L120 emitted from the plurality of light emission units 110 and the plurality of light emission units 120, respectively. Therefore, as compared with the above-described embodiment and the like, by enabling uniform irradiation while having a spot irradiation function with a high light density with respect to the irradiation target 1000, it becomes possible to measure a distance to an object at a short distance with higher resolution.

Note that, as schematically illustrated in FIG. 33, the plurality of light emission units 110 and the plurality of light emission units 120 preferably have different light emission areas (OA diameters W3 and W4). Specifically, the light emission area (OA diameter W3) of the plurality of light emission units 110 for spot irradiation is preferably smaller than the light emission area (OA diameter W4) of the plurality of light emission units 120 for uniform irradiation. Therefore, light beams for spot irradiation (the laser beams L110 (first light beam) applied to the irradiation target 1000 in spot shapes independent from each other) applied from the plurality of light emission units 110 are condensed smaller, and the target can be irradiated with a smaller spot. Furthermore, a wider range can be irradiated with the light beams for uniform irradiation applied from the plurality of light emission units 120 (the laser beam L120 (second light beam) overlapped with the light emitted from the adjacent light emission units 120 to irradiate a predetermined range of the irradiation target 1000 in a substantially uniform manner), and uniform irradiation of the irradiation target 1000 more uniformly with higher output becomes possible. Furthermore, accordingly, an opening width W1 of wiring connecting each of the plurality of light emission units 110 becomes smaller than an opening width W2 of wiring connecting each of the plurality of light emission units 120. Note that, although the number of light emission units for spot irradiation and the number of light emission units for uniform irradiation are the same in FIG. 33, they may be different. Furthermore, the light emission unit for spot irradiation and the light emission unit for uniform irradiation may have different far field patterns (FFPs).

Note that, in one embodiment described above, an example has been described in which the diffraction element 14 and the diffraction element 34 are configured as separate components, but diffractive optical surfaces may be arranged on both surfaces of one optical element or on one surface of one optical surface in an overlapping manner. Furthermore, FIG. 2 illustrates an example in which the diffraction element 34 is arranged at a subsequent stage of the collimator lens 13, but the arrangement position of the diffraction element 34 is not limited thereto, and for example, this may be arranged between the beam shaping unit 12 and the collimator lens 13.

Furthermore, the diffraction element 34 may be integrated with the microlens array 122, for example. At that time, for example, it is possible to employ a configuration that acts only on the laser beam L110 for spot irradiation or only on the laser beam L120 for uniform irradiation. Furthermore, different diffraction patterns can be formed by the laser beam L110 for spot irradiation and the laser beam L120 for uniform irradiation.

In one embodiment and the variation described above, the example in which a light emission pattern (for example, spot/spot, spot/uniform) is switched according to light emission switching control for the light emission element has been described, but the light emission region may be switched according to the light emission switching control for the light emission element.

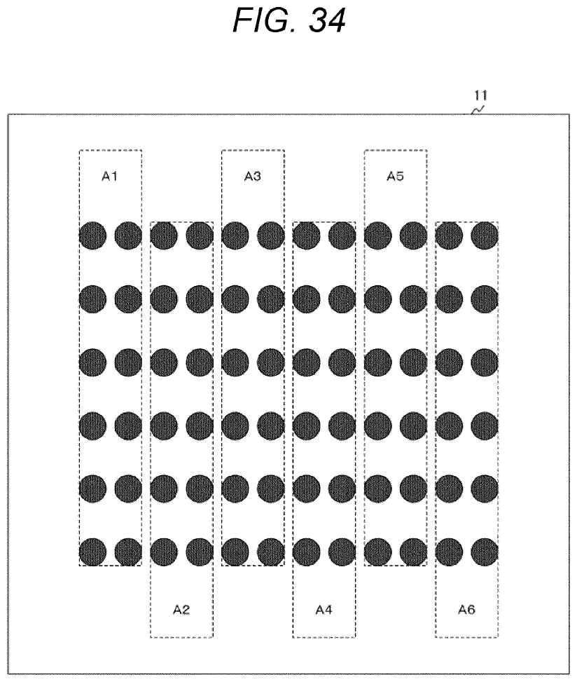

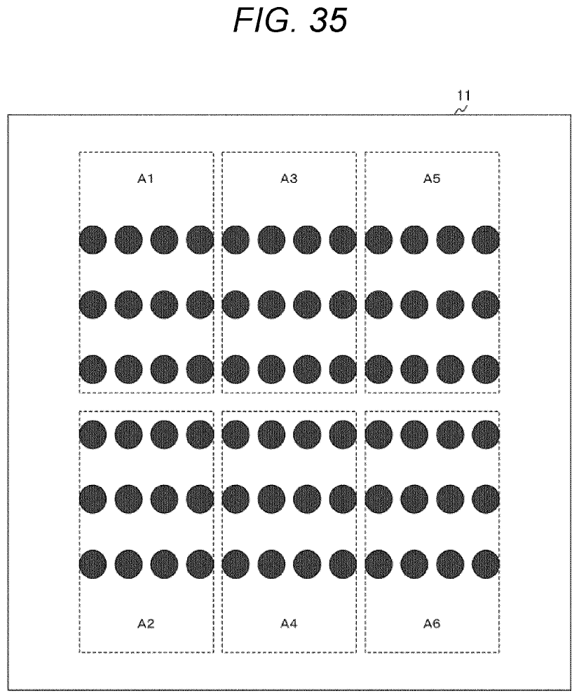

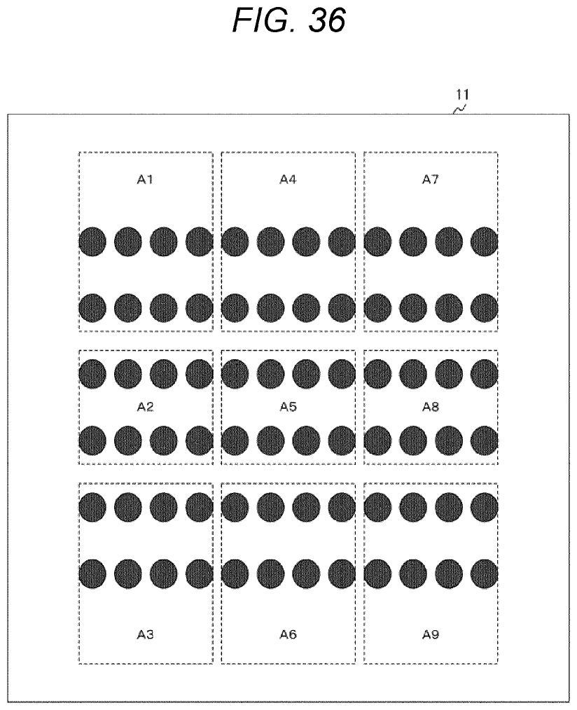

FIGS. 34 to 37 are diagrams illustrating examples of how to divide light emission regions. In the example in FIG. 34, a case is assumed where one region is formed for every plurality of columns (two columns in this example) and switching is performed for each region. In the example in FIG. 35, a case is assumed where one frame is further vertically divided into two parts to form quadrangle regions and switching is performed for each region. In the example in FIG. 36, a case is assumed where one frame is vertically divided into three parts and switching is performed for each region.

When the number of spots is increased and light intensity per spot is maintained, there is a possibility that power consumption increases to exceed safety standard for protecting eyes. In this respect, by switching the light emission in units of light emission regions, flexible adjustment can be performed. Switching of light emission may be performed for each frame, and may be performed for each block and the like in the frame. Furthermore, it is also possible to recognize a position of a target to be subjected to the ranging and allow the region to emit light.

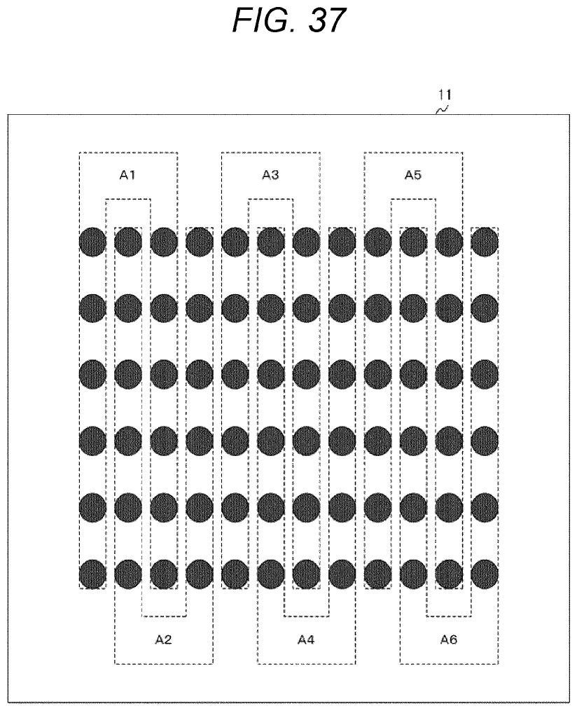

FIG. 37 is the diagram illustrating another example of how to divide light emission regions. In this example, an example is illustrated in which grouping is performed for every two columns in such a manner that every other columns are alternately combined. For example, first and third columns form a region Al, second and fourth columns form a region A2, fifth and seventh columns form a region A3, sixth and eighth columns form a region A4, ninth and eleventh columns form a region A5, and tenth and twelfths columns form a region A6. Therefore, switching of light emission may be controlled for every two columns. Therefore, it is possible to reduce power consumption by region switching and increase light output within the laser safety standard while taking multipath countermeasures.

Note that, light emission switching control different from the light emission switching control described in one embodiment and the variation may be performed on the light emission element. For example, light emission switching control of switching the light emission unit for spot irradiation and the light emission unit for uniform irradiation described above for each region may be performed.

In one embodiment described above, an example in which each of the light emission units 110 and 120 is separated by the mesa structure having the columnar mesa has been described, but there is no limitation. For example, the light emission unit 110 and the light emission unit 120 may be in one structure, and the light emission units may be separated by the current constriction region 148B of the current constriction layer 148 (by current constriction). In this manner, the light emission units 110 and 120 may be separated by a separation structure having no mesa structure.

Note that, the above embodiments illustrate an example for embodying the present technology, and matters in the embodiments and matters specifying the invention in claims have correspondence relationships. Similarly, the matters specifying the invention in claims and matters having the same names in the embodiments of the present technology have correspondence relationships. However, the present technology is not limited to the embodiments and can be embodied by making various modifications to the embodiments without departing from the gist thereof.

Note that, effects described in the present specification are merely examples and are not limited, and there may also be other effects.

Note that, the present technology may also have a following configuration.

(1)

An illumination device including:
a light emission element including a first light emission unit group including a plurality of first light emission units and a second light emission unit group including a plurality of second light emission units, a first electrode of the first light emission unit group and a second electrode of the second light emission unit group made common;
a first switching unit connected between a power supply and a third electrode of the first light emission unit group;
a second switching unit connected between the power supply and a fourth electrode of the second light emission unit group; and
at least one capacitor connected to a connection point between the power supply and the first switching unit and second switching unit.
   (2)

The illumination device according to (1), further including:
a first capacitor connected to a connection point between the power supply and the first switching unit, and a second capacitor connected to a connection point between the power supply and the second switching unit.
   (3)

The illumination device according to (1) or (2), further including:
a resistor or a transistor connected to an off-side terminal of the first switching unit; and
a resistor or a transistor connected to an off-side terminal of the second switching unit.
   (4)

The illumination device according to any one of (1) to (3), further including:
a resistor connected to a connection point between the first switching unit and the third electrode; and
a resistor connected to a connection point between the second switching unit and the fourth electrode.
   (5)

The illumination device according to any one of (1) to (3), further including:
a transistor connected to a connection point between the first switching unit and the third electrode; and
a transistor connected to a connection point between the second switching unit and the fourth electrode.
   (6)

The illumination device according to any one of (1) to (5), in which
the first switching unit and the second switching unit are complementarily driven switching units.
   (7)

The illumination device according to (6), in which the first switching unit and the second switching unit are transistors.

(8)

The illumination device according to any one of (1) to (7), in which
one capacitor is connected to the connection point between the power supply and the first switching unit and second switching unit.
   (9)

The illumination device according to any one of (1) to (8), in which
the first switching unit, the second switching unit, and drive circuits of the first switching unit and the second switching unit are configured by one integrated circuit.
   (10)

The illumination device according to any one of (1) to (9), in which
the light emission element includes a first light emission element and a second light emission element, and
the first light emission element includes the first light emission unit group, and the second light emission element includes the second light emission unit group.
   (11)

The illumination device according to any one of (1) to (10), in which
a light emission pattern is switched according to light emission switching control for the light emission element.
   (12)

The illumination device according to (11), in which
the light emission switching control switches between a spot irradiation pattern and a uniform irradiation pattern.
   (13)

The illumination device according to (11) or (12), in which
a light emission region is switched according to light emission switching control for the light emission element.
   (14)

The illumination device according to (12), further including:
a first optical member that makes a plurality of first light beams emitted from the plurality of first light emission units and a plurality of second light beams emitted from the plurality of second light emission units substantially parallel to emit;
a second optical member that shapes a beam shape of at least one of the plurality of first light beams or the plurality of second light beams, and emits the plurality of first light beams and the plurality of second light beams as light beams having different beam shapes; and
a third optical member that is arranged on optical paths of the plurality of first light beams and the plurality of second light beams, refracts or diffracts the plurality of first light beams to increase the number of spots with which the irradiation target is irradiated, and refracts or diffracts the plurality of second light beams to increase an overlapping range with the second light beams emitted from adjacent second light emission units,
in which
the plurality of first light beams emitted from the plurality of first light emission units is applied to the irradiation target in the spot irradiation pattern, and
the plurality of second light beams emitted from the plurality of second light emission units is overlapped with the second light beams emitted from partially adjacent second light emission units to irradiate a predetermined range of the irradiation target with the uniform irradiation pattern.
   (15)

A ranging device including:
the illumination device according to any one of (1) to (14);
a control unit that controls the illumination device;
a light reception unit that receives reflection light reflected by a target; and
a ranging unit that calculates a ranging distance from image data obtained by the light reception unit.

### REFERENCE SIGNS LIST

1 Illumination device
11 Light emission element
100 Ranging device
171 to 174 Light emission unit group
SW1 to SW4 Switching unit
C1 to C4 Decoupling capacitor
RA to RD Resistor
TrA to TrD, Tr1 to Tr4 Transistor

1. An illumination device comprising:
a light emission element including a first light emission unit group including a plurality of first light emission units and a second light emission unit group including a plurality of second light emission units, a first electrode of the first light emission unit group and a second electrode of the second light emission unit group made common;
a first switching unit connected between a power supply and a third electrode of the first light emission unit group;
a second switching unit connected between the power supply and a fourth electrode of the second light emission unit group; and
at least one capacitor connected to a connection point between the power supply and the first switching unit and second switching unit.

2. The illumination device according to claim 1, further comprising:
a first capacitor connected to a connection point between the power supply and the first switching unit, and a second capacitor connected to a connection point between the power supply and the second switching unit.

3. The illumination device according to claim 1, further comprising:
a resistor or a transistor connected to an off-side terminal of the first switching unit; and
a resistor or a transistor connected to an off-side terminal of the second switching unit.

4. The illumination device according to claim 1, further comprising:
a resistor connected to a connection point between the first switching unit and the third electrode; and
a resistor connected to a connection point between the second switching unit and the fourth electrode.

5. The illumination device according to claim 1, further comprising:
a transistor connected to a connection point between the first switching unit and the third electrode; and
a transistor connected to a connection point between the second switching unit and the fourth electrode.

6. The illumination device according to claim 1, wherein
the first switching unit and the second switching unit are complementarily driven switching units.

7. The illumination device according to claim 6, wherein
the first switching unit and the second switching unit are transistors.

8. The illumination device according to claim 1, wherein
one capacitor is connected to the connection point between the power supply and the first switching unit and second switching unit.

9. The illumination device according to claim 1, wherein
the first switching unit, the second switching unit, and drive circuits of the first switching unit and the second switching unit are configured by one integrated circuit.

10. The illumination device according to claim 1, wherein
the light emission element includes a first light emission element and a second light emission element, and
the first light emission element includes the first light emission unit group, and the second light emission element includes the second light emission unit group.

11. The illumination device according to claim 1, wherein
a light emission pattern is switched according to light emission switching control for the light emission element.

12. The illumination device according to claim 11, wherein
the light emission switching control switches between a spot irradiation pattern and a uniform irradiation pattern.

13. The illumination device according to claim 11, wherein
a light emission region is switched according to light emission switching control for the light emission element.

14. The illumination device according to claim 12, further comprising:
a first optical member that makes a plurality of first light beams emitted from the plurality of first light emission units and a plurality of second light beams emitted from the plurality of second light emission units substantially parallel to emit;
a second optical member that shapes a beam shape of at least one of the plurality of first light beams or the plurality of second light beams, and emits the plurality of first light beams and the plurality of second light beams as light beams having different beam shapes; and
a third optical member that is arranged on optical paths of the plurality of first light beams and the plurality of second light beams, refracts or diffracts the plurality of first light beams to increase the number of spots with which the irradiation target is irradiated, and refracts or diffracts the plurality of second light beams to increase an overlapping range with the second light beams emitted from adjacent second light emission units,
wherein
the plurality of first light beams emitted from the plurality of first light emission units is applied to the irradiation target in the spot irradiation pattern, and
the plurality of second light beams emitted from the plurality of second light emission units is overlapped with the second light beams emitted from partially adjacent second light emission units to irradiate a predetermined range of the irradiation target with the uniform irradiation pattern.

15. A ranging device comprising:
the illumination device according to claim 1;
a control unit that controls the illumination device;
a light reception unit that receives reflection light reflected by a target; and
a ranging unit that calculates a ranging distance from image data obtained by the light reception unit.
